(19) United States
(12) Patent Application Publication
(10) Pub. No.: US 2026/0220584 A1
(43) Pub. Date: Jul. 30, 2026

(54) SUPERVISOR FEEDBACK SYSTEM, ELECTRONIC DEVICE, AND RELATED METHODS

(71) Applicant: GN Hearing A/S, Ballerup (DK)

(72) Inventors: Sripad KOSURI, Ballerup (DK); Christian LILLELUND, Ballerup (DK); Ali ÖZKIL, Ballerup (DK)

(21) Appl. No.: 19/142,027

(22) PCT Filed: Dec. 20, 2022
(86) PCT No.: PCT/EP2022/087028

§ 371 Date: Jun. 20, 2025

(51) Int. Cl. G06Q 10/0639

(52) U.S. Cl. CPC G06Q 10/06398

(57) ABSTRACT

A method of operating a supervisor feedback system comprising a supervisor device, a first agent device, and a second agent device is disclosed. The method comprises obtaining first performance data comprising one or more first performance parameters associated with a performance of a first agent during one or more first calls; obtaining second performance data comprising one or more second performance parameters associated with a performance of a second agent during one or more second calls; determining, based on the first performance data and the second performance data, a notification scheme for notifying a supervisor of the performance of the first agent and the second agent; outputting, based on the notification scheme, one or more notifications.

The present disclosure relates to supervisor feedback and related tools, methods, and systems in particular for analysing, monitoring, evaluating, and/or providing feedback on the performance of one or more agents during one or more calls. Thus, a supervisor feedback system, an electronic device, and related methods, in particular a method of operating a supervisor feedback system comprising a supervisor device, a first agent device, and a second agent device are provided.

### BACKGROUND

With the rise of hybrid work and remote offices, supervisors are now often physically separated from their agents. Hence, they can no longer “walk the aisle” to get a sense of what's going on—and find out which agents to support and praise. This means that supervisors struggle and are less effective. Also, research shows that agents often are not very happy with the feedback and coaching they receive from their supervisors. The available tools for feedback, such as real-time feedback, are not able to measure agent well-being and performance optimally. They are complex, not real-time, and require a lot of analysis from the supervisor to be able to provide feedback to the agents. Supervisors are left with more or less random information and have to guess who they should spend their time on, when, and what they should focus on giving feedback on to improve performance of the agents.

### SUMMARY

Accordingly, there is a need for supervisor feedback systems, electronic devices, and methods of operating supervisor feedback systems with improved feedback on agents performances.

A method of operating a supervisor feedback system comprising a supervisor device, a first agent device, and a second agent device is disclosed. The method comprises obtaining first performance data comprising one or more first performance parameters associated with a performance of a first agent during one or more first calls. The method comprises obtaining second performance data comprising one or more second performance parameters associated with a performance of a second agent during one or more second calls. The method comprises determining, based on the first performance data and the second performance data, a notification scheme for notifying a supervisor of the performance of the first agent and the second agent. The method comprises outputting, based on the notification scheme, one or more notifications.

Further, an electronic device is disclosed. The electronic device comprises a memory, an interface, and one or more processors. The one or more processors are configured to obtain first performance data comprising one or more first performance parameters associated with a performance of a first agent during one or more first calls. The one or more processors are configured to obtain second performance data comprising one or more second performance parameters associated with a performance of a second agent during one or more second calls. The one or more processors are configured to determine, based on the first performance data and the second performance data, a notification scheme for notifying a supervisor of the performance of the first agent and the second agent. The one or more processors are configured to output, based on the notification scheme, one or more notifications.

The electronic device is configured to perform any of the steps of a method according to this disclosure, e.g., using the one or more processors, the interface, and/or the memory.

Also disclosed is a system, such as a supervisor feedback system, comprising an electronic device according to the disclosure, a first agent device, and a second agent device. In one or more embodiments or examples, the electronic device may be seen as a supervisor device. In one or more embodiments or examples, the electronic device may be seen as a server device. In one or more embodiments or examples, the system may comprise a supervisor device, a server device, a first agent device, and a second agent device.

It is an advantage of the present disclosure that a supervisor may be provided with an improved feedback of the performances during calls of a plurality of agents, such as performances of a first agent and a second agent during calls. The present disclosure provides improved notification schemes for notifying supervisors of the performance of a plurality of agents, such as a plurality of teams of agents. The present disclosure provides a tool for a supervisor to monitor the performances of a plurality of agents and be able to provide feedback to the agents in the best possible way, in turn allowing the supervisors to improve the coaching and development of their agents. For example, the present disclosure may provide a tool for a supervisor to identify or target which agent(s) need feedback and when. It may be appreciated that the present disclosure provides a tool for a supervisor to be able to remotely analyse, monitor, evaluate, and/or provide feedback on the performance of a plurality of agents during one or more calls. The present disclosure may provide an improved notification of a supervisor regarding the performance of a plurality of agents, such as a first agent and a second agent, in turn enabling the supervisor to provide more relevant feedback to the agent(s). It may be appreciated that the present disclosure may provide relative thresholds for notifying instead of fixed thresholds. For example, the present disclosure may provide real-time intelligent feedback based on agents' strengths and weaknesses. Consequently, the present disclosure may provide a tool with customized notification schemes for a supervisor. It may be advantageous to determine customized notification schemes that provide more relevant notifications to the supervisor about the agents he/she has to supervise, instead of having standard notification schemes that overflow the supervisor with notifications, which may be irrelevant, and lead to irrelevant feedback and coaching from the supervisor to his agents. In other words, the present disclosure may provide logic to alert about relevant changes or actions needed which may be tailored to and customizable for both specific agents and teams, such as teams of agents. For example, in the present relevant prioritized notifications may be generated on a team level and/or across teams. In turn, supervisors may get the most relevant feedback, about who to focus on, and what to focus on, rather than generic rules and fixed thresholds, that doesn't take the individuals and changes over time into account. This gives the supervisors an opportunity to support agents when they need it, and praise them for top performances, instead of random and awkwardly timed check-ins, supervisors may check in when needed. The feedback may be delivered through intelligent notifications with actionable guidance. In this way, supervisors are not required to look at reports or an “analytics screen” all day. It may be appreciated that appreciated that the one or more notifications may notify the supervisor of which agents to target, such as which agents to provide feedback to and/or to coach, and when to do it. The present disclosure may provide better human connection in a call center, and in turn happier agents as the present disclosure enables the supervisor to be more effective and give agents better coaching.

### BRIEF DESCRIPTION OF THE DRAWINGS

The above and other features and advantages of the present invention will become readily apparent to those skilled in the art by the following detailed description of exemplary embodiments thereof with reference to the attached drawings, in which:

FIG. 1 schematically illustrates an exemplary supervisor feedback system comprising an electronic device according to the present disclosure, and

FIGS. 2A-2C are flow diagrams of an exemplary method according to the present disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

A method of operating a supervisor feedback system comprising a supervisor device and a plurality of agent devices, such as a first agent device and a second agent device, is disclosed. The method may be seen as a computer implemented method. In other words, the method may be seen as a computer implemented method where one or more computers are configured to operate the supervisor feedback system, e.g., automatically operating the supervisor feedback system. The system may optionally comprise a server device comprising one or more interfaces, one or more processors, and a memory. The server device may be configured on a cloud, such as a cloud network. The system may be a system for monitoring, handling, analysing and/or providing feedback to a supervisor on the performance of a plurality of agents during calls, such as a meeting conversation, a video/telephone conference conversation, and/or a call, e.g. a telephone or VOIP call. The calls may be seen as calls performed between an agent, such as a first agent and/or a second agent, and an interlocutor, such as a customer, a caller, and/or a person receiving support. The system may for example comprise, be part of, or act as a call center system for monitoring, handling, analysing and/or providing feedback to a supervisor on the performance of a plurality of agents during calls. The supervisor device and the agent devices may be part of a call center system for monitoring, handling, analysing and/or providing feedback to a supervisor on the performance of a plurality of agents during calls. Different operations and/or steps of the method and/or the system as disclosed herein may be performed at different devices, such as at the electronic device (e.g., supervisor device and/or server device), at an agent device, such as at the first agent device and/or the second agent device, and/or at the server device. In one or more examples or embodiments, the supervisor feedback system comprises a plurality of agent devices to be supervised by the supervisor device, such as a third agent device, a fourth agent device, etc. In one or more examples or embodiments, the supervisor feedback system comprises at least five agent devices to be supervised by the supervisor device, at least ten agent devices to be supervised by the supervisor device, at least twenty agent devices to be supervised by the supervisor device, or at least fifty agent devices to be supervised by the supervisor device. The operations and/or steps as disclosed herein may also apply for a plurality of agents, such as a third agent device, a fourth agent device, etc.

An advantage of the present disclosure may be the provision of a tool for supervising, monitoring, and/or coaching a large amount of agent devices, such as large number of agents, remotely from a supervisor device in a more effective and comprehensive way for the supervisor, which in turn allows the supervisor to effectively target agents and provide more relevant feedback to the agents.

In one or more examples or embodiments, the supervisor feedback system comprises a plurality of supervisor devices, where each supervisor device is associated with a plurality of agent devices to supervise. In one or more examples or embodiments, the supervisor feedback system may comprise a plurality of manager devices, where each manager device is associated with a plurality of supervisor devices to supervise. In other words, a manager may be seen as a person supervising one or more supervisors. It may be appreciated that each supervisor device may be associated with a plurality of teams of agent devices, e.g., each supervisor may supervise a plurality of teams of agents. It may be appreciated that each manager device may be associated with a plurality of teams of supervisor devices, e.g., each manager may supervise a plurality of teams of supervisors. The description associated with a supervisor device as disclosed herein may also apply to the description of a manager device. In other words, a manager device may be configured to supervise one or more supervisor devices and a manager device may be configured to be used by a manager.

The supervisor device may be seen as an electronic device comprising an interface, one or more processors, and a memory. The supervisor device may for example be or comprise a mobile phone, such as a smartphone, a computer, such as a laptop computer or PC, or a tablet computer, and/or an accessory device, such as a smart watch. The supervisor device may for example be a user device, such as a mobile phone or a computer, configured to monitor, handle, analyse and/or provide feedback to a supervisor on the performance of a plurality of agents during calls. A supervisor device as disclosed herein is configured to be operated by a supervisor. A supervisor device as disclosed herein may be associated with a plurality of agent devices to be supervised. The user of the supervisor device may be seen as a supervisor. A supervisor as disclosed herein may be seen as a person supervising, coaching, and/or managing a plurality of agents, such as agents of a call center. An agent as disclosed herein may be seen as an agent of a call center, such as a support call center, an after sales call center, a contact center, a marketing call center, a reception call center, a sales call center, or companies where an important part of the employees' job is to have conversations with customers. An agent device as disclosed herein may be seen as an electronic device configured to be operated by an agent for performing and receiving calls to and from an interlocutor. An agent device as disclosed herein may comprise an interface, one or more processors, and a memory. An agent device may for example be or comprise a mobile phone, such as a smartphone, a computer, such as a laptop computer or PC, or a tablet computer, and/or an accessory device, such as a smart watch. The system may be configured to use edge processing for performing one or more operations and/or steps as disclosed herein. For example, an edge processing device may be connected to an agent device and/or a supervisor device for performing one or more of the operations as disclosed herein. Different operations and/or steps of the method and/or the system may be performed at different devices, such as at an agent device, an edge processing device connected to the agent device, a supervisor device, an edge processing device connected to the supervisor device, and/or at a server device.

The method comprises obtaining, such as using a processor of the supervisor device and/or via an interface of the supervisor device, first performance data comprising one or more first performance parameters associated with a performance of a first agent during one or more first calls. Obtaining as disclosed herein may comprise one or more of receiving, retrieving, determining, and/or generating.

The first performance data may be seen as data indicative of a performance of the first agent during one or more first calls. The first performance data may comprise one or more first performance parameters indicative of a performance of the first agent when performing or after having performed one or more first calls with one or more interlocutors. An interlocutor as disclosed herein may be seen as a person that an agent has a call with, such as a customer, a caller, or just a person receiving support, after sales, or the like over a call with an agent. The first performance data, such as the one or more first performance parameters, may be indicative of a performance of the first agent during a single first call or during a plurality of first calls. The first performance data may comprise or be indicative of one or more first performance parameters over time for one or more first calls. In one or more example methods, a plurality of first performance parameters may be obtained and/or determined for each first call. For example, a plurality of first performance parameters may be obtained and/or determined based on different metrics during a single first call. In one or more example methods, a first performance parameter may be obtained and/or determined for a plurality of calls, such as a first performance parameter indicative of a performance of the first agent during a plurality of calls. This may for example be a mean performance of the first agent during a plurality of first calls. A first performance parameter may comprise or be indicative of a speech performance parameter, a call performance parameter, a conversation performance parameter, a tone performance parameter, a sentiment performance parameter, an audio quality parameter, and/or an interlocutor satisfaction parameter of the first agent during one or more first calls. The first performance data may comprise one or more first performance parameters being one or more scores associated with the performance of the first agent during one or more first calls. A score associated with the performance of the first agent may be denoted a first score. A score may be a speech performance score indicating a level of performance of speech of the first agent during one or more first calls. In other words, a speech performance score may indicate how well an agent's speech performed during a call. A score may be a call performance score indicating a level of performance of call of the first agent during one or more first calls. In other words, a call performance score may indicate how well a call went for an agent. A score may be a conversation performance score indicating a level of performance of conversation of the first agent during one or more first calls. In other words, a conversation performance score may indicate how well a conversation between an agent and an interlocutor went during a call. A score may be a tone performance score indicating a level of performance of tone of the first agent during one or more first calls. In other words, a tone performance score may indicate how well an agent's tone performed during a call. A score may be a sentiment performance score indicating a level of performance of sentiment of the first agent during one or more first calls. In other words, a sentiment performance score may indicate how well an agent's sentiment performed during a call. A score may be an interlocutor satisfaction score indicating a level of satisfaction of an interlocutor during one or more first calls. In other words, an interlocutor satisfaction score may indicate how well an agent performed during a call in view of the level of satisfaction of the interlocutor. A first call may be seen as a call performed between the first agent and an interlocutor. A first call may be seen as a call that has been performed with the first agent device.

In one or more example methods, the first performance data may be obtained by the supervisor device from the first agent device and/or from the server device. In one or more example methods, the first performance data may be obtained by the server device from the first agent device. In one or more example methods, the first performance data may be determined at the supervisor device, e.g., based on data obtained from the server device and/or from the first agent device. In one or more example methods, the first performance data may be determined at the server device, e.g., based on data obtained from the first agent device. In one or more example methods, the first performance data may be determined at the first agent device, and then transmitted to the server device and/or the supervisor device.

The method comprises obtaining, such as using a processor of the supervisor device and/or via an interface of the supervisor device, second performance data comprising one or more second performance parameters associated with a performance of a second agent during one or more second calls.

The second performance data may be seen as data indicative of a performance of the second agent during one or more second calls. The second performance data may comprise one or more second performance parameters indicative of a performance of the second agent when performing or after having performed one or more second calls with one or more interlocutors. The second performance data, such as the second performance parameters, may be indicative of a performance of the second agent during a single second call or during a plurality of second calls. In one or more example methods, a plurality of second performance parameters may be obtained and/or determined for each second call. For example, a plurality of second performance parameters may be obtained and/or determined based on different metrics during a single second call. In one or more example methods, a second performance parameter may be obtained and/or determined for a plurality of calls, such as a second performance parameters indicative of a performance of the second agent during a plurality of calls. The second performance data may comprise or be indicative of one or more second performance parameters over time for one or more second calls. This may for example be a mean performance of the second agent during a plurality of second calls. A second performance parameter may comprise or be indicative of a speech performance parameter, a call performance parameter, a conversation performance parameter, a tone performance parameter, a sentiment performance parameter, and/or an interlocutor satisfaction parameter of the second agent during one or more second calls. The second performance data may comprise one or more second performance parameters being one or more scores associated with the performance of the second agent during one or more second calls. A score associated with the performance of the second agent may be denoted a second score. A score may be a speech performance score indicating a level of performance of speech of the second agent during one or more second calls. In other words, a speech performance score may indicate how well an agent's speech performed during a call. A score may be a call performance score indicating a level of performance of call of the second agent during one or more second calls. In other words, a call performance score may indicate how well a call went for an agent. A score may be a conversation performance score indicating a level of performance of conversation of the second agent during one or more second calls. In other words, a conversation performance score may indicate how well a conversation between an agent and an interlocutor went during a call. A score may be a tone performance score indicating a level of performance of tone of the second agent during one or more second calls. In other words, a tone performance score may indicate how well an agent's tone performed during a call. A score may be a sentiment performance score indicating a level of performance of sentiment of the second agent during one or more second calls. In other words, a sentiment performance score may indicate how well an agent's sentiment performed during a call. A score may be an interlocutor satisfaction score indicating a level of satisfaction of an interlocutor during one or more second calls. In other words, an interlocutor satisfaction score may indicate how well an agent performed during a call in view of the level of satisfaction of the interlocutor. A second call may be seen as a call performed between the second agent and an interlocutor. A second call may be seen as a call that has been performed with the second agent device.

In one or more example methods, the second performance data may be obtained by the supervisor device from the second agent device and/or from the server device. In one or more example methods, the second performance data may be obtained by the server device from the second agent device. In one or more example methods, the second performance data may be determined at the supervisor device, e.g., based on data obtained from the server device and/or from the second agent device. In one or more example methods, the second performance data may be determined at the server device, e.g., based on data obtained from the second agent device. In one or more example methods, the second performance data may be determined at the second agent device, and then transmitted to the server device and/or the supervisor device.

The method comprises determining, such as using a processor of the supervisor device and based on the first performance data and/or the second performance data, a notification scheme for notifying a supervisor, such as for notifying the supervisor device, of the performance of the first agent and/or the second agent. A notification scheme as disclosed herein may be seen as a scheme defining a set of rules, conditions, and/or criteria for notifying a supervisor of the performance(s) of the first agent and/or the second agent. For example, a notification scheme may define which notifications to be determined, e.g., a content of a notification, such as which agent's performance a notification shall be notifying the supervisor about, which notification(s) to output, when to output a notification, the conditions, or criteria for determining a notification, and/or the conditions or criteria for outputting a notification. In one or more example methods, determining the notification scheme comprises determining a first primary notification indicative of a performance of the first agent during one or more first calls, and/or determining a second primary notification indicative of a performance of the second agent during one or more second calls. In one or more example methods, determining a notification scheme comprises determining one or more criteria comprising a first criterion, and determining whether the one or more first performance parameters and/or the one or more second performance parameters satisfy the first criterion. In one or more example methods, in accordance with the one or more first performance parameters and/or the one or more second performance parameters satisfying the first criterion, determining and/or outputting one or more notifications. A notification scheme may comprise one or more thresholds for the performance parameters for determining whether a notification shall be determined or not and/or whether a notification shall be outputted or not. For example, a notification may be determined and/or outputted when a performance parameter is above or equal to a certain threshold and/or below or equal to another threshold. It may be appreciated that the notification scheme may define a prioritization for notifying an agent, e.g., when multiple criteria are satisfied, the notification scheme may comprise prioritization rules determining the priority of different notification(s), such as which notification(s) are to be outputted with highest priority. In one or more example methods, a notification scheme may comprise one or more rules for grouping a plurality of notifications. For example, a notification scheme may group a plurality of notifications of the same type and/or are less relevant to the supervisor, e.g., in order to not overflow the supervisor with many separate notifications of the same type. A notification scheme may comprise rules for how many notifications that may be outputted to the supervisor, and/or a frequency for notifying the supervisor (such as a time period between two notifications). In one or more example methods, the notification scheme may be determined by the supervisor device, the first agent device, the second agent device, and/or the server device. In one or more example methods, the notification scheme may be determined by the first agent device, the second agent device, and/or the server device, and then obtained by the supervisor device from the first agent device, the second agent device, and/or from the server device.

The method comprises outputting, based on the notification scheme, one or more notifications. In one or more example methods, the method comprises outputting, based on the notification scheme or according to the notification scheme, one or more notifications to the supervisor device from the server device, the first agent device, and/or the second agent device. In one or more example methods, the method comprises outputting, based on the notification scheme and using the processor and/or via the interface of the supervisor device, one or more notifications. In one or more example methods, the method comprises determining, based on the notification scheme and the first performance data and/or second performance data, the one or more notifications. In one or more example methods, the one or more notifications may be determined by the supervisor device, the server device, the first agent device, and/or the second agent device. For example, the supervisor device may fetch the one or more notifications from the server device, the first agent device, and/or the second agent device. Alternatively or additionally, the server device, the first agent device, and/or the second agent device may push the one or more notifications to the supervisor device. In one or more example methods, outputting one or more notifications based on the notification scheme comprises outputting one or more notifications based on or according to the set of rules defined by the notification scheme. In one or more example methods, the one or more notifications may be determined based on the first performance data, the first performance parameters, the second performance data, and/or the second performance parameters. In other words, the one or more notifications may comprise information associated with the first performance data, the one or more first performance parameters, the second performance data, and/or the one or more second performance parameters.

For example, the one or more notifications may notify the supervisor of the performance of the first agent and/or the second agent on the supervisor device. In other words, the one or more notifications may provide feedback to the supervisor on the performance of the first agent and/or the second agent on the supervisor device. It may be appreciated that the one or more notifications may notify the supervisor of which agents to target, such as which agents to provide feedback to and/or to coach, and when to do it. In one or more example methods, the one or more notifications may comprise a recommendation to the supervisor about the feedback to provide to the agents. A notification as disclosed herein may comprise feedback text associated with the agent's performance. For example, when the performance data indicates that an agent have had his best performance of the week, a notification may comprise a feedback message stating “The first agent have had his best call of the week. He deserves a high-five.”. In one or more example methods, a notification may comprise one or more graphical elements or representations associated with the performance of an agent. For example, a notification may comprise a graphical element representing an achievement of an agent. For example, when an agent have had his best performance of the week, the notification may comprise a graphical element representing a medal. For example, when the performance data indicates that an agent has been in call with at least 15 total seconds of negative interlocutor tone, a notification may comprise a feedback message stating, “The agent is currently talking with a seemingly frustrated or angry interlocutor. Please consider giving the agent a call after the call has terminated or reassure the agent by sending him feedback on the call.”. For example, when the performance data indicates that an agent is in a call with at least 15 total seconds of background noise above 80 db, a notification may comprise a feedback message stating, “The agent is sitting in too much background noise, which may affect a call quality.”. For example, when the performance data indicates that an agent have had at least two calls with at least 15 total seconds of negative interlocutor tone in each, a notification may comprise a feedback message stating, “The agent has been talking to multiple frustrated interlocutors and may need support.”. For example, when the performance data indicates that an agent have had an average agent tone in last three calls which is in the top 10% performance for the agent compared to a normal daily average, a notification may comprise a feedback message stating, “The agent is on a streak with a better tone than usually, he/she deserves a high-five”. For example, when the performance data indicates that an agent have had an average agent tone in last ten calls which is in the bottom 10% performance for the agent compared to a normal daily average, a notification may comprise a feedback message stating, “The agent sounds more flat than usual, consider check in with him/her”. The notifications as disclosed herein may provide a real-time feedback to the supervisor about the agents he/she is supervising. It may be appreciated that the notifications as disclosed herein may be associated with a single call or a plurality of calls, such as across several calls of an agent. A notification as disclosed herein may comprising a nudging, such as a nudging for action of the supervisor.

In one or more example methods, determining a notification scheme comprises determining a first notification scheme associated with the first agent. The first notification scheme may be seen as a scheme defining a set of first rules, first conditions, and/or first criteria associated with the first agent for notifying a supervisor of the performance of the first agent.

In one or more example methods, determining a notification scheme comprises determining a second notification scheme associated with the second agent. The second notification scheme may be seen as a scheme defining a set of second rules, second conditions, and/or second criteria associated with the second agent for notifying a supervisor of the performance of the second agent.

It may be appreciated that the first notification scheme is different from the second notification scheme. A notification scheme may be customized based on the individual agent, such as based on an agent's performance, an agent's level, an agent's team, an agent's state, an agent's personal preferences, and/or based on timing parameters. It may be advantageous to determine customized notification schemes that provide more relevant notifications to the supervisor about the agents he has to supervise, instead of having standard notification schemes that overflow the supervisor with notifications, which may be irrelevant, and lead to irrelevant feedback and coaching from the supervisor to his agents.

In one or more example methods, outputting the one or more notifications comprises outputting one or more first notifications according to the first notification scheme. In one or more example methods, the method comprises determining, based on the first notification scheme and the first performance data, the one or more first notifications. The one or more first notifications may be seen as notifications providing feedback on the first agent's performance. In one or more example methods, the one or more first notifications may be determined by the supervisor device, the server device, and/or the first agent device. In one or more example methods, the method comprises outputting, based on the first notification scheme or according to the first notification scheme, one or more first notifications to the supervisor device from the server device, and/or the first agent device. In one or more example methods, the method comprises outputting, based on the first notification scheme and using the processor and/or via the interface of the supervisor device, one or more first notifications.

In one or more example methods, outputting the one or more notifications comprises outputting one or more second notifications according to the second notification scheme. In one or more example methods, the method comprises determining, based on the second notification scheme and the second performance data, the one or more second notifications.

In one or more example methods, the method comprises determining, based on historical first performance parameters, a first ranking score of the one or more first performance parameters. In one or more example methods, determining the first ranking score comprises comparing the one or more first performance parameters with historical or previous first performance parameters. In other words, the method comprises determining a level of the one or more first performance parameters by comparing them to historical first performance parameters. In one or more example methods, determining the first ranking score comprises determining a ranking score of one or more of: a first primary performance parameter, a first secondary performance parameter, a first tertiary performance parameter, and a first quaternary performance parameter as disclosed herein, based on the historical first performance parameters.

A historical performance parameter as disclosed herein may be seen as a performance parameter from one or more previous calls between an agent and an interlocutor. Performance parameters may be ranked based on or compared with historical performance parameters from the same day, from the past week, from the past month, and/or from the past year.

A ranking score as disclosed herein, such as the first ranking score and/or a second ranking score, may be seen as scores indicating a ranking of a performance parameter of an agent based on or in comparison with historical performance parameters of the agent. In one or more example methods, a ranking score may be determined based on historical performance parameters of other agents, such as historical performance parameters of a team of agents. In one or more example methods, the first ranking score may be determined by the supervisor device, the server device, and/or the first agent device. A ranking score as disclosed herein may rank one or more performance parameters. A ranking score may rank a single performance parameter and/or a plurality of performance parameters. In other words, a ranking score may be determined for each performance parameter and/or a ranking score may be determined for a plurality of performance parameters combined, such as an averaged ranking score for a plurality of performance parameters. A ranking score may be indicative of a ranking of one or more of: a speech performance parameter, a call performance parameter, a conversation performance parameter, a tone performance parameter, a sentiment performance parameter, and an interlocutor satisfaction parameter. It may be appreciated that a ranking score may be determined for each call and/or for a plurality of calls, such as an averaged ranking score for a plurality of calls.

In one or more example methods, the method comprises determining, based on historical second performance parameters, a second ranking score of the one or more second performance parameters. The description in relation to the first ranking score may also apply to the description of the second ranking score.

In one or more example methods, the method comprises determining whether the first ranking score satisfies a first notification criterion. A notification criterion as disclosed herein may be seen as a criterion that has to be satisfied for a notification to be determined and/or outputted.

In other words, determining whether the first ranking score satisfies a first notification criterion may comprise determining whether the first ranking score is above, below, or equal to a first notification threshold and/or is within a certain range indicative of the first notification criterion. In other words, the first ranking score may satisfy the first notification criterion when the first ranking score is above or equal to a first notification threshold. For example, the first ranking score may satisfy the first notification criterion when the first ranking score is above or equal to a first notification threshold. In other words, when the first ranking score satisfies the first notification criterion, the first ranking score has been determined to be relevant to output to the supervisor. The first ranking score may satisfy the first notification criterion when the first ranking score is indicative of a good performance compared to previous performances, such as indicative of a better performance than previous performances.

In one or more example methods, in accordance with the first ranking score satisfying the first notification criterion, the method comprises determining one or more first notifications. In one or more example methods, in accordance with the first ranking score satisfying the first notification criterion, the method comprises updating the first notification scheme.

In one or more example methods, in accordance with the first ranking score satisfying the first notification criterion, outputting one or more notifications comprises outputting one or more first notifications indicative of the first ranking score according to the first notification scheme. For example, the first ranking score may satisfy the first notification criterion when the first agent have had his best performance of the day, the week, the month, and/or the year. Another example may be that the first ranking score may satisfy the first notification criterion when the first agent have had his best speech performance parameter, call performance parameter, conversation performance parameter, tone performance parameter, sentiment performance parameter, and/or interlocutor satisfaction parameter of the day, the week, the month, and/or the year.

In other words, the supervisor, such as the supervisor device, may be notified when the performance of the first agent is highly ranked compared to previous performances. In one or more example methods, the supervisor, such as the supervisor device, may only be notified when the performance of the first agent is highly ranked compared to previous performances.

In one or more example methods, in accordance with the first ranking score not satisfying the first notification criterion, the method comprises refraining from outputting one or more first notifications.

In one or more example methods, the method comprises determining whether the first ranking score satisfies a second notification criterion. In other words, determining whether the first ranking score satisfies a second notification criterion may comprise determining whether the first ranking score is above, below, or equal to a second notification threshold and/or is within a certain range indicative of the second notification criterion. In other words, the first ranking score may satisfy the second notification criterion when the first ranking score is below or equal to a second notification threshold. For example, the first ranking score may satisfy the second notification criterion when the first ranking score is above or equal to a second notification threshold. In other words, when the first ranking score satisfies the second notification criterion, the first ranking score has been determined to be relevant to output to the supervisor. The first ranking score may satisfy the second notification criterion when the first ranking score is indicative of a bad performance compared to previous performances, such as indicative of a worse performance than previous performances.

In one or more example methods, in accordance with the first ranking score satisfying the second notification criterion, the method comprises determining one or more first notifications. In one or more example methods, in accordance with the first ranking score satisfying the second notification criterion, the method comprises updating the first notification scheme.

In one or more example methods, in accordance with the first ranking score satisfying the second notification criterion, outputting one or more notifications comprises outputting one or more first notifications indicative of the first ranking score according to the first notification scheme. For example, the first ranking score may satisfy the second notification criterion when the first agent have had his worst performance of the day, the week, the month, and/or the year. Another example may be that the first ranking score may satisfy the second notification criterion when the first agent have had his worse speech performance parameter, call performance parameter, conversation performance parameter, tone performance parameter, sentiment performance parameter, and/or interlocutor satisfaction parameter of the day, the week, the month, and/or the year.

In other words, the supervisor, such as the supervisor device, may be notified when the performance of the first agent is lower ranked compared to previous performances. In one or more example methods, the supervisor, such as the supervisor device, may only be notified when the performance of the first agent is lower ranked compared to previous performances.

In one or more example methods, in accordance with the first ranking score not satisfying the second notification criterion, the method comprises refraining from outputting one or more first notifications.

By ranking the performance parameters and conditioning the output of the notifications to the supervisor, such as to the supervisor device, based on the ranking, the supervisor may be provided with more relevant feedback on the agents he has to supervise instead of being overflowed with notifications. This may provide a tool for the supervisor to effectively monitor the performances of a plurality of agents and be able to provide feedback to the agents in the best possible way, in turn allowing the supervisors to improve the coaching and development of their agents.

In one or more example methods, the method comprises determining, based on historical second performance parameters, a second ranking score of the one or more second performance parameters.

In one or more example methods, the method comprises determining whether the second ranking score satisfies a third notification criterion.

In one or more example methods, in accordance with the second ranking score satisfying the third notification criterion, outputting one or more notifications comprises outputting one or more second notifications indicative of the second ranking score according to the second notification scheme.

In one or more example methods, in accordance with the second ranking score not satisfying the third notification criterion, the method comprises refraining from outputting one or more second notifications.

In one or more example methods, obtaining first performance data comprises obtaining first agent metric data indicative of a metric of the first agent during the one or more first calls and determining a first primary performance parameter based on the first agent metric data. In other words, the first performance data may comprise the first primary performance parameter. A metric of an agent as disclosed herein may be seen as a measure of a parameter during a call between an agent and an interlocutor, such as an agent metric. For example, a metric of an agent may be a metric associated with the speech of the agent.

A metric may comprise one or more of: a call duration, a number of interruptions, a number of long pauses, a reaction time, a silence time, a background noise, a sentiment metric of the agent, and a tone metric of the agent. The first primary performance parameter may be determined based on one or more of: a call duration, a number of interruptions, a number of long pauses, a reaction time, a silence time, a background noise, a sentiment metric of the agent, and a tone metric of the agent. A metric of an agent as disclosed herein may for example comprise an agent tone metric, an agent intonation metric, a tone friendliness, an energy level, a tone confidence, an agent power or volume metric, an agent pitch metric, an agent voice quality metric, a linguistic metric, an acoustic metric, and/or an agent spectral band energy metric.

In one or more example methods, the first primary performance parameter may be obtained by the supervisor device from the first agent device and/or from the server device. In one or more example methods, the first primary performance parameter may be determined by the first agent device and obtained by the server device from the first agent device. In one or more example methods, the first primary performance parameter may be determined at the supervisor device, e.g., based on first agent metric data obtained from the server device and/or from the first agent device. In one or more example methods, the first primary performance parameter may be determined at the server device, e.g., based on first agent metric data obtained from the first agent device. In one or more example methods, the first primary performance parameter may be determined at the first agent device, and then transmitted to the server device and/or the supervisor device.

In one or more example methods, determining a notification scheme comprises determining a first primary notification scheme based on the first primary performance parameter and/or the first agent metric data. In one or more example methods, determining the first primary notification scheme comprises determining a first primary notification, based on the first primary performance parameter and/or the first agent metric data, indicative of a performance of the first agent during one or more first calls. In one or more example methods, determining a first primary notification scheme comprises determining one or more criteria comprising a first primary criterion, and determining whether the first primary performance parameter satisfies the first primary criterion. In one or more example methods, in accordance with the first primary performance parameter satisfying the first primary criterion, determining and/or outputting one or more first primary notifications.

In one or more example methods, outputting one or more notifications comprises outputting a first primary notification based on the first primary notification scheme, e.g., where the first primary notification is indicative of a performance of the first agent for the metric during the one or more first calls. In one or more example methods, the method comprises determining, based on the first primary notification scheme, the first agent metric data, and/or the first primary performance parameter, the first primary notification. In other words, the first primary notification may comprise information associated with the first agent metric data and/or the first primary performance parameter.

In one or more example methods, obtaining second performance data comprises obtaining second agent metric data indicative of a metric of the second agent during the one or more second calls and determining a second primary performance parameter based on the second agent metric data.

In one or more example methods, determining a notification scheme comprises determining a second primary notification scheme based on the second primary performance parameter and/or the second agent metric data.

In one or more example methods, outputting one or more notifications comprises outputting a second primary notification based on the second primary notification scheme.

In one or more example methods, obtaining the first agent metric data comprises obtaining first tone metric data indicative of a tone of the first agent during the one or more first calls. In one or more example methods, the first tone metric data comprises one or more tone metrics indicative of a tone of the first agent.

A tone metric may be seen as indicative of a tone of an agent, such as of a speaker. For example, the tone metric data may be indicative of, or comprise a first tone parameter being a mean tone of an agent over a call and/or a tone outcome of a call (e.g. the overall tone of the agent when the call is terminated). Tone metric data may be indicative of a mean tone of an agent over a call. Tone metric data may comprise one or more speech metrics. In other words, the tone metric data may comprise one or more speech metrics e.g. interruptions, overtalks, long pauses, high or low speech rate, high or low intonation, turn or flip of an interlocutor (e.g. turning a customer from negative to positive or vice-versa), and/or responsiveness. The tone metric data may comprise count of events, e.g. count of one or more metrics. A tone metric may for example be indicative of a negative tone or a positive tone.

In one or more example methods, obtaining the first performance data comprises determining a first secondary performance parameter based on the first tone metric data. In other words, the first performance data may comprise the first secondary performance parameter. In one or more example methods, the first secondary performance parameter may be obtained by the supervisor device from the first agent device and/or from the server device. In one or more example methods, the first secondary performance parameter may be determined by the first agent device and obtained by the server device from the first agent device. In one or more example methods, the first secondary performance parameter may be determined at the supervisor device, e.g., based on first agent metric data obtained from the server device and/or from the first agent device. In one or more example methods, the first secondary performance parameter may be determined at the server device, e.g., based on first agent metric data obtained from the first agent device. In one or more example methods, the first secondary performance parameter may be determined at the first agent device, and then transmitted to the server device and/or the supervisor device.

In one or more example methods, determining a notification scheme comprises determining a first secondary notification scheme based on the first secondary performance parameter. In one or more example methods, determining the first secondary notification scheme comprises determining a first secondary notification, based on the first secondary performance parameter and/or the first tone metric data, indicative of a tone performance of the first agent during one or more first calls. In one or more example methods, determining a first secondary notification scheme comprises determining one or more criteria comprising a first secondary criterion, and determining whether the first secondary performance parameter satisfies the first secondary criterion. In one or more example methods, in accordance with the first secondary performance parameter satisfying the first secondary criterion, determining and/or outputting one or more first secondary notifications.

In one or more example methods, outputting one or more notifications comprises outputting a first secondary notification based on the first secondary notification scheme, e.g., where the first secondary notification is indicative of a performance of the first agent for the tone metric during the one or more first calls. In one or more example methods, the method comprises determining, based on the first secondary notification scheme, the first tone metric data, and/or the first secondary performance parameter, the first secondary notification. In other words, the first secondary notification may comprise information associated with the first tone metric data and/or the first secondary performance parameter.

In one or more example methods, obtaining the second agent metric data comprises obtaining second tone metric data indicative of a tone of the second agent during the one or more second calls.

In one or more example methods, obtaining the second performance data comprises determining a second secondary performance parameter based on the second tone metric data.

In one or more example methods, determining a notification scheme comprises determining a second secondary notification scheme based on the second secondary performance parameter.

In one or more example methods, outputting one or more notifications comprises outputting a second secondary notification based on the second secondary notification scheme.

In one or more example methods, obtaining the first agent metric data comprises obtaining first sentiment metric data indicative of a sentiment of the first agent during the one or more first calls. In one or more example methods, the first sentiment metric data comprises one or more sentiment metrics indicative of a sentiment of the first agent.

A sentiment metric may be seen as indicative of a sentiment state of an agent, such as of a speaker. For example, the sentiment metric data may be indicative of, or comprise a first sentiment parameter being a mean sentiment of an agent over a call and/or a sentiment outcome of a call (e.g. the overall sentiment state of the agent when the call is terminated). A sentiment metric may comprise one or more of a sentiment state, a sentiment type identifier, sentiment level(s), and a confidence score. In one or more example methods, the sentiment metric data may comprise a sentiment metric over time. For example, the sentiment metric data may be indicative of a trend over time of a sentiment metric, e.g., is a sentiment metric going from negative to more positive over a call, how was the sentiment metric at the beginning of a call compared to the sentiment metric at the end of the call, and/or was there a peak of a sentiment metric at some point in time, such as extreme anger at some point in the call.

A sentiment metric may be indicative of a primary sentiment state of an agent. In other words, a sentiment metric may be indicative of a primary emotion of the agent. A sentiment metric may be indicative of a dominating sentiment state and/or a first sentiment state in time of the agent. A primary sentiment state may be one of disappointed, bored, afraid, sad, negative, very negative, frustrated, fearful, panicking, hesitant, dissatisfied, angry, surprised, worried, wondering, not understanding, thinking, neutral, positive, very positive, glad, friendly, confident, excited, pleased, satisfied, aroused, content, relaxed, energetic, enthusiastic, service-minded, helpful, interested, and happy. In one or more example methods, a primary sentiment state of the agent may be selected from a primary set of sentiment states.

A sentiment type identifier may be indicative of a sentiment state of an agent. A sentiment type identifier may for example be a label, a number or value, such as an integer, corresponding to a specific sentiment (state), a sentiment type and/or a sentiment class. For example, a sentiment type identifier may be selected from a set of sentiment type identifiers ST_ID_SET_1, where ST_ID_SET_1 comprises a plurality of sentiment type identifiers, e.g. including at least three, four, five or more sentiment type identifiers.

In one or more exemplary methods, the set of sentiment type identifiers ST_ID_SET_1 is given by:

$$ST\_ID \_SET \_ 1 = \{ 1 , 2 , 3 , 4 , 5 \} ,$$

where “1” is indicative of a sentiment, such as “Very negative”, “2” is indicative of a sentiment, such as “Negative”, “3” is indicative of a sentiment, such as “Neutral”, optional “4” is indicative of a sentiment, such as “Positive”, and optional “5” is indicative of a sentiment, such as “Very positive”.

In one or more exemplary methods, the set of sentiment type identifiers ST_ID_SET_1 is given by:

$$ST\_ID \_SET \_ 1 = \{ ” Very negative ” , “ Negative ” , “ Neutral ” , “ Positive ” , “ Very positive ” \} ,$$

e.g. where “Very negative” and/or “Very positive” is optional.

In one or more exemplary methods, the set of sentiment type identifiers ST_ID_SET_1 is given by:

$$ST\_ID \_SET \_ 1 = \{ 1 , 2 , 3 , 4 , 5 \} ,$$

where “1” is indicative of a sentiment, such as “Angry”, “2” is indicative of a sentiment, such as “Low Energy”, “3” is indicative of a sentiment, such as “OK Energy”, optional “4” is indicative of a sentiment, such as “Friendly, engaged, energetic”, and optional “5” is indicative of a sentiment, such as “Highly engaged”.

A set of sentiment type identifiers, such as the primary set of sentiment type identifiers and/or the secondary set of sentiment type identifiers, may comprise at least three or at least four different sentiment type identifiers, such as five, six, seven, eight, nine, or more sentiment type identifiers.

A sentiment metric may comprise a sentiment level. A sentiment level may indicate a level of a sentiment type. For example, when the sentiment type corresponds to the sentiment state “positive”, a sentiment level may be indicative of or correspond to a degree of the sentiment “positive”, e.g. at a scale, e.g. from 0 to 1 or from 1 to 10, or selected from “low”, “medium”, and “high”. In other words, a sentiment level of a sentiment metric may be on a scale, e.g. from 0 to 1 or from 1 to 10.

A sentiment metric may comprise a confidence score. A confidence score of a sentiment metric may be indicative of a score or a probability of a sentiment metric, e.g. sentiment type identifier and/or sentiment level, being correct, e.g. the sentiment state or sentiment type (as identified by the sentiment type identifier of the sentiment metric) being correct. For example, a sentiment confidence score, SCS=0.88 may be indicative of a probability of 88% that the sentiment type, e.g. being “positive”, is correct.

In one or more example methods, obtaining the first performance data comprises determining a first tertiary performance parameter based on the first sentiment metric data. In other words, the first performance data may comprise the first tertiary performance parameter. In one or more example methods, the first tertiary performance parameter may be obtained by the supervisor device from the first agent device and/or from the server device. In one or more example methods, the first tertiary performance parameter may be determined by the first agent device and obtained by the server device from the first agent device. In one or more example methods, the first tertiary performance parameter may be determined at the supervisor device, e.g., based on first agent metric data obtained from the server device and/or from the first agent device. In one or more example methods, the first tertiary performance parameter may be determined at the server device, e.g., based on first agent metric data obtained from the first agent device. In one or more example methods, the first tertiary performance parameter may be determined at the first agent device, and then transmitted to the server device and/or the supervisor device.

In one or more example methods, determining a notification scheme comprises determining a first tertiary notification scheme based on the first tertiary performance parameter. In one or more example methods, determining the first tertiary notification scheme comprises determining a first tertiary notification, based on the first tertiary performance parameter and/or the first sentiment metric data, indicative of a sentiment performance of the first agent during one or more first calls. In one or more example methods, determining a first tertiary notification scheme comprises determining one or more criteria comprising a first tertiary criterion, and determining whether the first tertiary performance parameter satisfies the first tertiary criterion. In one or more example methods, in accordance with the first tertiary performance parameter satisfying the first tertiary criterion, determining and/or outputting one or more first tertiary notifications.

In one or more example methods, outputting one or more notifications comprises outputting a first tertiary notification based on the first tertiary notification scheme, e.g., where the first tertiary notification is indicative of a performance of the first agent for the sentiment metric during the one or more first calls. In one or more example methods, the method comprises determining, based on the first tertiary notification scheme, the first sentiment metric data, and/or the first tertiary performance parameter, the first tertiary notification. In other words, the first tertiary notification may comprise information associated with the first sentiment metric data and/or the first tertiary performance parameter.

In one or more example methods, obtaining the second agent metric data comprises obtaining second sentiment metric data indicative of a sentiment of the second agent during the one or more second calls.

In one or more example methods, obtaining the second performance data comprises determining a second tertiary performance parameter based on the second sentiment metric data.

In one or more example methods, determining a notification scheme comprises determining a second tertiary notification scheme based on the second tertiary performance parameter.

In one or more example methods, outputting one or more notifications comprises outputting a second tertiary notification based on the second tertiary notification scheme.

In one or more example methods, obtaining the first performance data comprises obtaining first interlocutor metric data indicative of a metric of a first interlocutor during the one or more first calls and determining a first quaternary performance parameter based on the first interlocutor metric data.

In other words, the first performance data may comprise the first quaternary performance parameter. A metric of an interlocutor as disclosed herein may be seen as a measure of a parameter during a call between an agent and an interlocutor, such as an interlocutor metric. For example, a metric of an interlocutor may be a metric associated with the speech of the interlocutor. A metric may comprise one or more of: a number of interruptions of the interlocutor, a number of long pauses interlocutor, a reaction time of the interlocutor, a silence time of the interlocutor, a sentiment metric of the interlocutor, and a tone metric of the interlocutor. The first quaternary performance parameter may be determined based on one or more of: a number of interruptions of the interlocutor, a number of long pauses interlocutor, a reaction time of the interlocutor, a silence time of the interlocutor, a sentiment metric of the interlocutor, and a tone metric of the interlocutor. A metric of an interlocutor as disclosed herein may for example comprise an interlocutor tone metric, an interlocutor intonation metric, an interlocutor power or volume metric, an interlocutor pitch metric, an interlocutor voice quality metric, a linguistic metric, an acoustic metric, and/or an interlocutor spectral band energy metric.

In one or more example methods, the first quaternary performance parameter may be obtained by the supervisor device from the first agent device and/or from the server device. In one or more example methods, the first quaternary performance parameter may be determined by the first agent device and obtained by the server device from the first agent device. In one or more example methods, the first quaternary performance parameter may be determined at the supervisor device, e.g., based on first agent metric data obtained from the server device and/or from the first agent device. In one or more example methods, the first quaternary performance parameter may be determined at the server device, e.g., based on first agent metric data obtained from the first agent device. In one or more example methods, the first quaternary performance parameter may be determined at the first agent device, and then transmitted to the server device and/or the supervisor device.

In one or more example methods, determining a notification scheme comprises determining a first quaternary notification scheme based on the first quaternary performance parameter and/or the first interlocutor metric data. In one or more example methods, determining the first quaternary notification scheme comprises determining a first quaternary notification, based on the first quaternary performance parameter and/or the first interlocutor metric data, indicative of a level of satisfaction of the interlocutor during one or more first calls. In one or more example methods, determining a first quaternary notification scheme comprises determining one or more criteria comprising a first quaternary criterion, and determining whether the first quaternary performance parameter satisfies the first quaternary criterion. In one or more example methods, in accordance with the first quaternary performance parameter satisfying the first quaternary criterion, determining and/or outputting one or more first quaternary notifications.

In one or more example methods, outputting one or more notifications comprises outputting a first quaternary notification based on the first quaternary notification scheme, e.g., where the first quaternary notification is indicative of a level of satisfaction of the interlocutor during the one or more first calls.

In one or more example methods, the method comprises determining, based on the first quaternary notification scheme, the first interlocutor metric data, and/or the first quaternary performance parameter, the first quaternary notification. In other words, the first quaternary notification may comprise information associated with the first interlocutor metric data and/or the first quaternary performance parameter.

In one or more example methods, obtaining second performance data comprises obtaining second interlocutor metric data indicative of a metric of the second interlocutor during the one or more second calls and determining a second quaternary performance parameter based on the second interlocutor metric data.

In one or more example methods, determining a notification scheme comprises determining a second quaternary notification scheme based on the second quaternary performance parameter and/or the second interlocutor metric data.

In one or more example methods, outputting one or more notifications comprises outputting a second quaternary notification based on the second quaternary notification scheme.

In one or more example methods, determining the notification scheme comprises determining, based on the first tone metric data and/or the first sentiment metric data, a first quinary notification scheme.

In one or more example methods, determining the first quinary notification scheme comprises determining a first quinary notification, based on the first tone metric data and/or the first sentiment metric data, indicative of a state of the first agent during one or more first calls. In one or more example methods, determining a first quinary notification scheme comprises determining one or more criteria comprising a first quinary criterion, and determining whether the first tone metric data and/or the first sentiment metric data satisfy the first quinary criterion. In one or more example methods, in accordance with the first tone metric data and/or the first sentiment metric data satisfying the first quinary criterion, determining and/or outputting one or more first quinary notifications. For example, when the first tone metric data and/or the first sentiment metric data satisfy the first quinary criterion, it may be determined that the state of the first agent during the one or more first calls is unwell. For example, the first tone metric data and/or the first sentiment metric data may indicate that the first agent has been unwell for a certain call or for a period of time. The supervisor may act on this and improve the wellbeing of the agent by providing feedback and/or coaching to the first agent. The first tone metric data and/or the first sentiment metric data may satisfy the first quinary criterion when a first tone score and/or a first sentiment score is falling below a certain threshold.

In one or more example methods, outputting one or more notifications comprises outputting, based on the first quinary notification scheme, a first quinary notification indicative of a state of the first agent during the one or more first calls. In one or more example methods, the method comprises determining, based on the first quinary notification scheme, the first tone metric data, and/or the first sentiment metric data, the first quinary notification. In other words, the first quinary notification may comprise information associated with the first tone metric data and/or the first sentiment metric data. It may be appreciated that a state of an agent may be determined based on the tone metric data and/or the sentiment metric data. A state of an agent may be seen as a mental state and/or sentimental state of the agent. For example, it may be determined that an agent is unwell based on the tone metric data and/or the sentiment metric data. A supervisor may then be alerted via a notification that an agent is unwell. The supervisor may then take action to improve the wellbeing of the agent.

In one or more example methods, determining the notification scheme comprises determining, based on the second tone metric data and/or the second sentiment metric data, a second quinary notification scheme.

In one or more example methods, outputting one or more notifications comprises outputting, based on the second quinary notification scheme, a second quinary notification indicative of a state of the second agent during the one or more second calls.

In one or more example methods, determining a notification scheme comprises determining, based on the first performance data, a first agent performance representation. An agent performance representation as disclosed herein, such as the first agent performance representation, may be or comprise a description, such as a text description, indicating an agent performance. The description, such as text description may be included in a notification as disclosed herein. An agent performance representation as disclosed herein may be seen as a representation, such as graphical representation, of the performance of an agent during one or more calls with one or more interlocutors. For example, an agent performance representation may comprise a graph representing an agent score on the Y-axis and the time of the X-axis. The supervisor may thereby be able to follow and/or get an overview of the performance of the agent over time, such as over a day, a week, a month, and/or a year. The agent performance representation may comprise representations of other agents, such as graphical representations of other agents. This may allow the supervisor to compare the performance of the agent, such as first agent, with the performance of other agents. The other agents may for example be agents of the same team, agents with the same level, agents with the same position, agents in different countries, and/or agents of different teams. The agent performance representation may colour-code portions of the graph depending on whether the portions are above an average score of the agent or below an average score of the agent. The agent performance representation may comprise graphical representations, such as icons, representing achievements of the agent over time. The agent performance representation may comprise graphical representations of one or more metrics of the agent and/or the interlocutor as disclosed herein, such as graphical representations of a call duration, a number of interruptions, a number of long pauses, a reaction time, a silence time, a background noise, a sentiment metric of the agent, a tone metric of the agent, a tone metric of the interlocutor, a sentiment metric of the interlocutor, and/or a level of satisfaction of the interlocutor. The agent performance representation may comprise graphical representations of one or more metrics in the form of percentage bar(s) indicating a percentage status of the metric(s) and/or a difference in percentage of the metric(s) compared to historical metric data. For example, the agent performance representation may comprise a percentage bar indicating the percentage of interruptions in calls for an agent during the day and the percentual difference of interruptions compared to the last day. In one or more example methods, an agent performance representation comprises a dashboard for visualizing the performance of the agent. It may be appreciated that the supervisor may be provided with an intuitive dashboard to learn more agent events, as well as overall trends and development over time of the agents. In one or more example methods, a dashboard may be associated with a notification as disclosed herein. For example, a supervisor may by providing a user input in response to a notification get access to a dashboard and vice-versa. For example, a dashboard may be determined based on a notification, and may comprise relevant information in view of the notification.

In one or more example methods, outputting one or more notifications comprises outputting, such as via an interface and/or using the processor of the supervisor device, a user interface indicative of the first agent performance representation. In one or more example methods, outputting a user interface comprises determining a user interface indicative of the first agent performance representation. In one or more example methods, outputting the user interface comprises including the first agent representation in the user interface. In one or more example methods, outputting the user interface comprises displaying a first user interface indicative of the first agent performance representation. In one or more exemplary methods, outputting the first agent performance representation may comprise displaying, via the interface of the supervisor device, e.g., via a display of the supervisor device, a first user interface indicative of the first agent performance representation. It may be appreciated that a user interface as disclosed herein may comprising a user interface object indicating a dating of a notification. For example, a user interface may comprise a user interface object indicating whether a notification is new or not.

A user interface may comprise one or more, such as a plurality of, user interface objects. For example, the first user interface may comprise one or more first user interface objects, such as a first primary user interface object and/or a first secondary user interface object. A user interface object may refer herein to a graphical representation of an object that is displayed on an interface of the supervisor device, such as a display. The user interface object may be user-interactive, or selectable by a user input. For example, an image (e.g., icon), a button, and text each optionally constituting a user interface object. The user interface object may form part of a widget. A widget may be seen as a mini-application that may be used by the user, e.g., supervisor.

In one or more example methods, determining a notification scheme comprises determining, based on the second performance data, a second agent performance representation.

In one or more example methods, outputting one or more notifications comprises outputting, such as via an interface and/or using the processor of the supervisor device, a user interface indicative of the second agent performance representation.

In one or more example methods, an agent performance representation and/or a user interface may be obtained by the supervisor device from the first agent device, the second agent device, and/or from the server device. In one or more example methods, an agent performance representation and/or a user interface may be determined by the first agent device and/or the second agent device and obtained by the server device from the first agent device and/or the second agent device. In one or more example methods, an agent performance representation and/or a user interface may be determined at the supervisor device, e.g., based on performance data obtained from the server device, the first agent device, and/or the second agent device. In one or more example methods, an agent performance representation and/or a user interface may be determined at the server device, e.g., based on performance data obtained from the first agent device and/or the second agent device. In one or more example methods, an agent performance representation and/or a user interface may be determined at the first agent device and/or the second agent device, and then transmitted to the server device and/or the supervisor device.

In one or more example methods, the method comprises obtaining first tertiary user input indicative of a closing of the user interface, and in response to the first tertiary user input, closing the user interface, such as closing the user interface comprising one or more notifications.

In one or more example methods, the method comprises determining, based on the first performance data, a first primary user interface object comprising one or more input fields. In other words, the method comprises determining a first primary user interface object based on the one or more first performance parameters. For example, the method may comprise determining a first user interface object being a feedback message template, such as a text feedback template, for providing a feedback message to the first agent as a feedback to the first performance data. The feedback message template may comprise one or more input fields for the supervisor to write or complete a feedback message to an agent based on the feedback message template. The feedback message template may for example be a blank message feedback template addressed to the first agent, so that the supervisor may write a text feedback message via the one or more input fields and/or record an audio/video feedback message via the one or more input fields, and then easily forward the feedback message to the first agent.

In one or more example methods, outputting the user interface comprises outputting a first primary user interface comprising the first primary user interface object. In other words, the method comprises outputting the first primary user interface comprising the one or more input fields.

For example, the method may comprise outputting a first user interface object comprising a feedback message template, such as a text feedback template and/or audio/video feedback template, for providing a feedback message to the first agent as a feedback to the first performance data. The method may comprise outputting a feedback message template comprising one or more input fields for the supervisor to write or complete a feedback message to an agent based on the feedback message template. The method may comprise outputting a blank message feedback template addressed to the first agent, so that the supervisor may write a text feedback message via the one or more input fields and/or record an audio/video feedback message via the one or more input fields, and then easily forward the feedback message to the first agent. This may provide a tool for the supervisor to provide customized feedback to an agent directly from a notification regarding the performance of the agent in a simple and effective manner.

In one or more example methods, a user interface object may be obtained by the supervisor device from the first agent device, the second agent device, and/or from the server device. In one or more example methods, a user interface object may be determined by the first agent device and/or the second agent device and obtained by the server device from the first agent device and/or the second agent device. In one or more example methods, a user interface object may be determined at the supervisor device, e.g., based on performance data obtained from the server device, the first agent device, and/or the second agent device. In one or more example methods, a user interface object may be determined at the server device, e.g., based on performance data obtained from the first agent device and/or the second agent device. In one or more example methods, a user interface object may be determined at the first agent device and/or the second agent device, and then transmitted to the server device and/or the supervisor device.

In one or more example methods, the method comprises determining, based on the second performance data, a second primary user interface object comprising one or more input fields.

In one or more example methods, outputting the user interface comprises outputting a second primary user interface comprising the second primary user interface object. In one or more example methods, obtaining, from the supervisor, such as via an interface of the supervisor device, a first primary user input associated with the first primary user interface object. In other words, the method comprises obtaining, from the supervisor, e.g., via an interface of the supervisor device and via the one or more input fields, a first primary user input. In other words, the supervisor may write or type a text feedback message via the one or more input fields and/or record an audio/video feedback message via the one or more input fields, in response to the output of a blank message feedback template addressed to the first agent, and then easily forward the feedback message to the first agent. This may provide a tool for the supervisor to provide customized feedback to an agent directly from a notification regarding the performance of the agent in a simple and effective manner.

In one or more example methods, in response to the first primary user input, outputting the first primary user interface comprises outputting a first primary agent feedback message. In other words, in response to the supervisor providing the first primary user input, the method comprises outputting a first primary agent feedback message. An agent feedback message as disclosed herein may be determined at the supervisor device and be outputted to the server device and/or an agent device. An agent feedback message as disclosed herein may be determined at the server device and be outputted to an agent device.

In one or more example methods, obtaining, from the supervisor, such as via an interface of the supervisor device, a second primary user input associated with the second primary user interface object.

In one or more example methods, in response to the second agent primary user input, outputting the second agent primary user interface comprises outputting a second agent primary agent feedback message.

In one or more example methods, the method comprises determining, based on the first performance data, a first secondary agent feedback message. In other words, the method comprises determining a first secondary agent feedback message based on the one or more first performance parameters. For example, determining a first secondary feedback message may comprise determining an automatic feedback message to the first agent based on the first agent's performance. In other words, the first secondary feedback message may be automatically generated based on the first performance data without the supervisor having to type anything. An automatic feedback message may comprise feedback text associated with the agent's performance. For example, when an agent have had his best performance of the week, the feedback message may state “You have had your best call of the week, well done! Continue the great work.”. In one or more example methods, a feedback message may comprise one or more graphical elements or representations associated with the performance of an agent. For example, a feedback message may comprise a graphical element representing an achievement of an agent. For example, when an agent have had his best performance of the week, the feedback message may comprise a graphical element representing a medal. A feedback message may be determined by obtaining standard text strings and/or phrases, e.g., stored on a memory, where the standard text strings and/or phrases correspond to one or more performance parameters of the agent.

In other words, example methods, the method comprises determining, based on the first secondary agent feedback message, a first secondary user interface object. In other words, the method comprises determining a first secondary user interface object based on the one or more first performance parameters. For example, the method may comprise determining a first secondary user interface object being a feedback message template, such as a text feedback template, based on the first secondary feedback message, for providing a feedback message to the first agent as a feedback to the first performance data. The feedback message template may include the first secondary agent feedback message. The feedback message template may for example include an automatically generated feedback message comprising feedback text associated with the agent's performance, so that the supervisor may be provided with a tool for providing feedback to the agent in a simpler and more effective way.

In one or more example methods, outputting the user interface comprises outputting a first secondary user interface comprising the first secondary user interface object. In one or more example methods, outputting the first secondary user interface comprises outputting the first secondary user interface comprising the first secondary user interface object to the first agent device, e.g., from the supervisor device and/or the server device. In one or more example methods, outputting the first secondary user interface comprises displaying, via and interface of the supervisor device, such as on a display of the supervisor device, the first secondary user interface comprising the first secondary user interface object. It may be appreciated that the supervisor may be able to visualize the first secondary agent feedback message before being outputted to the server device and/or the first agent device.

In one or more example methods, the method comprises determining, based on the second performance data, a second secondary agent feedback message.

In other words, example methods, the method comprises determining, based on the second secondary agent feedback message, a second secondary user interface object.

In one or more example methods, outputting the user interface comprises outputting a second secondary user interface comprising the second secondary user interface object. In one or more example methods, the method comprises obtaining, from the supervisor, a first secondary user input associated with the first secondary user interface object.

In other words, the method comprises obtaining, from the supervisor, e.g., via an interface of the supervisor device, a first secondary user input. In other words, the supervisor may review and/or edit the first secondary agent feedback message via one or more input fields and/or record an audio/video feedback message via one or more input fields, in response to the output of an automatically generated feedback message addressed to the first agent. For example, the supervisor may review and/or edit the first secondary agent feedback message before being outputted or sent out to the server device and/or first agent device. In other words, the supervisor may be able to confirm or decline the first secondary agent feedback message to be outputted by providing the first secondary user input in response to the first secondary user interface object. This may provide a tool for the supervisor to provide faster customized feedback to an agent directly from a notification regarding the performance of the agent in a simple and effective manner. This may allow the supervisor to supervise a larger number of agents while still being able to provide helpful feedback and coaching.

In one or more example methods, in response to the first secondary user input, outputting the first secondary user interface comprises outputting the first secondary agent feedback message. In other words, in response to the first secondary user input being indicative of an acceptance of the first secondary agent feedback message, procced with outputting the first secondary agent feedback message.

In one or more example methods, in response to the first secondary user input, outputting the first secondary user interface comprises refraining from outputting the first secondary agent feedback message, e.g., when the first secondary user input is indicative of decline of the first secondary agent feedback message from the supervisor.

In one or more example methods, outputting the first secondary user interface comprises outputting, such as transmitting, the first secondary agent feedback message to the first agent device, e.g., from the supervisor device and/or the server device.

In one or more example methods, the method comprises obtaining, from the supervisor, a second secondary user input associated with the second secondary user interface object.

In one or more example methods, in response to the second secondary user input, outputting the second secondary user interface comprises outputting the second secondary agent feedback message.

In one or more example methods, determining the notification scheme comprises determining one or more first timing parameters based on one or more of: an activity of the first agent, a time-zone of the first agent and/or the supervisor, and calendar data of the first agent and/or the supervisor. It may be appreciated that an activity of the first agent and/or the supervisor, a time-zone of the first agent and/or the supervisor, and/or calendar data of the first agent and/or the supervisor may be seen as data obtained by the server device, the supervisor device, and/or an agent device, from the server device, the supervisor device, and/or an agent device, depending on where the notification scheme is determined. In one or more example methods, determining the notification scheme comprises determining one or more first timing parameters for the one or more notifications. In other words, the notification scheme may be determined based on one or more of: an activity of the first agent and/or the supervisor, a time-zone of the first agent and/or the supervisor, and calendar data of the first agent and/or the supervisor. By determining a notification scheme based on timing parameters it may be possible to customize the outputting of notifications to the supervisor based on the availability of the supervisor and/or the agent.

For example, it may be advantageous to notify the supervisor about a performance of the first agent when the supervisor is available to react on the notification and when the first agent is available to receive feedback from the supervisor in response to the notification. For example, when the supervisor and the first agent are located in different time zones, the notification scheme may be determined such that the notifications to the supervisor about the first agent are outputted preferably when both the supervisor and the first agent are available. For example, if the supervisor and the agent have an overlap of availability of one hour during the day, the notification scheme may be determined such that the notifications about the first agent are prioritized to be outputted during that hour. An availability of the supervisor may be determined based on one or more of: an activity of the supervisor, a time-zone of the supervisor, and/or calendar data of the supervisor. An activity of the agent may be determined based on one or more of: an activity of the agent, a time-zone of the agent, and/or calendar data of the agent. In another scenario it may be advantageous to notify the supervisor about a performance of the first agent when the agent has finished a call, e.g., between two calls, where the first agent is available to receive feedback from the supervisor in response to the notification.

In one or more example methods, outputting the one or more notifications comprises outputting the one or more notifications based on the one or more first timing parameters.

In one or more example methods, the method comprises determining, based on the one or more first timing parameters, the one or more first notifications. The one or more first notifications may be seen as notifications providing feedback on the first agent's performance. In one or more example methods, the method comprises outputting, based on the one or more first timing parameters, one or more first notifications to the supervisor device from the server device, and/or the first agent device.

In one or more example methods, determining the notification scheme comprises determining the notification scheme based on one or more agent preferences. For example, an agent may provide a set of agent preferences, such as personal preferences, for determining the notification scheme. For example, an agent may activate a privacy mode for a certain period, where notifications are not sent to the supervisor and/or the agent does not want to receive feedback.

In one or more example methods, determining the notification scheme comprises determining one or more second timing parameters based on one or more of: an activity of the second agent, a time-zone of the second agent and/or the supervisor, and calendar data of the second agent and/or the supervisor.

In one or more example methods, outputting the one or more notifications comprises outputting the one or more notifications based on the one or more second timing parameters.

An electronic device comprising a memory, an interface, and one or more processors is disclosed. The electronic device, such as the one or more processors, are configured to perform any of the methods and/or steps of the methods according to this disclosure. In one or more embodiments or examples, the electronic device may be seen as a supervisor device as disclosed herein, an agent device as disclosed herein, and/or a server device as disclosed herein. It may be appreciated that different operations and/or steps of the method, the electronic device, and/or the system as disclosed herein may be performed at different devices, such as at the electronic device (e.g., supervisor device and/or server device), at an agent device, such as at the first agent device and/or the second agent device, and/or at the server device.

The one or more processors are configured to obtain, such as via the interface, first performance data comprising one or more first performance parameters associated with a performance of a first agent during one or more first calls. The one or more processors are configured to obtain, such as via the interface, second performance data comprising one or more second performance parameters associated with a performance of a second agent during one or more second calls. The one or more processors are configured to determine, based on the first performance data and the second performance data, a notification scheme for notifying a supervisor of the performance of the first agent and the second agent. The one or more processors are configured to output, such as via the interface and based on the notification scheme, one or more notifications.

In one or more embodiments or examples, the electronic device may be implemented as supervisor device. The supervisor device may be seen as an electronic device comprising an interface, one or more processors, and a memory. The supervisor device may for example be or comprise a mobile phone, such as a smartphone, a computer, such as a laptop computer or PC, or a tablet computer, and/or an accessory device, such as a smart watch. The supervisor device may for example be a user device, such as a mobile phone or a computer, configured to monitor, handle, analyse and/or provide feedback to a supervisor on the performance of a plurality of agents during calls. A supervisor device as disclosed herein is configured to be operated by a supervisor. A supervisor device as disclosed herein may be associated with a plurality of agent devices to be supervised.

In one or more embodiments or examples, the electronic device may be implemented as agent device. The agent device may be configured to obtain first audio input, such as first audio input from the call between the agent and an interlocutor. For example, the electronic device may act as call agent device where the user may be an agent, such as an agent of a call center, such as a support call center, an after sales call center, a marketing call center, a reception call center, a sales call center, or companies where an important part of the employees' job is to have conversations with customers. The electronic device may for example be a user device, such as a mobile phone or a computer, configured to record first audio input from a first agent, such as record the first agent speaking or talking. The electronic device may be configured to obtain one or more audio signals, such as generate one or more audio signals, including a first audio signal. The first audio signal may be based on the first audio input.

An electronic device may for example comprise one or more of a mobile phone, a computer, a tablet, an accessory device such as a smart watch, and/or a server device. The electronic device may for example be a user device, such as a mobile phone or a computer, configured to perform a call between a user and another person.

The interface of the electronic device may comprise one or more of: a display, a keyboard, a wireless interface, a wired interface, an audio interface, and an interface to a global network, such as the internet or a telecommunications network. The electronic device may be configured to detect a user input, e.g., via the display, the audio interface, and/or the keyboard. The user input may comprise a touch input from the user, for example when the first display comprises a touch-sensitive display. The user input may comprise a contact on the touch sensitive display and/or a keyboard comprised in or connected to the electronic device. A touch-sensitive display may provide a first user interface and/or a second user interface (such as an input interface) and an output interface between the electronic device and the user. The processor of the electronic device may be configured to receive and/or send electrical signals from/to touch-sensitive display. A touch-sensitive display may be configured to display visual output to the user, e.g. the first speaker representation and/or the second speaker representation. The visual output optionally includes graphics, text, icons, video, audio icons, and any combination thereof (collectively termed “graphics”). For example, some, most, or all of the visual output may be seen as corresponding to user-interface objects.

The processor of the electronic device may be configured to display, on the interface, e.g. display, one or more user interfaces as disclosed herein, such as user interface screens. A user interface may be referred to as a user interface screen.

An input, such as the user input as disclosed herein, may comprise a touch (e.g. a tap, a force touch, a long press), a click (such as a mouse click), a typing (such as a typing on a keyboard), an audio input (such as a voice input), and/or a movement of contact (e.g. a swipe gesture, e.g. for toggling). The movement on contact may be detected by a touch sensitive surface, e.g. on the first display of the electronic device. Thus, the display may be a touch sensitive display. The input (such as user input) may comprise a lift off.

Also disclosed is a system, such as a supervisor feedback system, comprising an electronic device according to the disclosure, a first agent device, and a second agent device. In one or more embodiments or examples, the electronic device may be seen as a supervisor device. In one or more embodiments or examples, the electronic device may be seen as a server device. In one or more embodiments or examples, the system may comprise a supervisor device, a server device, a first agent device, and a second agent device.

The system may be a system for monitoring, handling, analysing and/or providing feedback to a supervisor on the performance of a plurality of agents during calls, such as a meeting conversation, a video/telephone conference conversation, and/or a call, e.g. a telephone or VoIP call.

The system may for example comprise, be part of, or act as a call center system for monitoring, handling, analysing and/or providing feedback to a supervisor on the performance of a plurality of agents during calls.

It is to be understood that a description of a feature in relation to method(s) is also applicable to the corresponding feature in the electronic device and/or system.

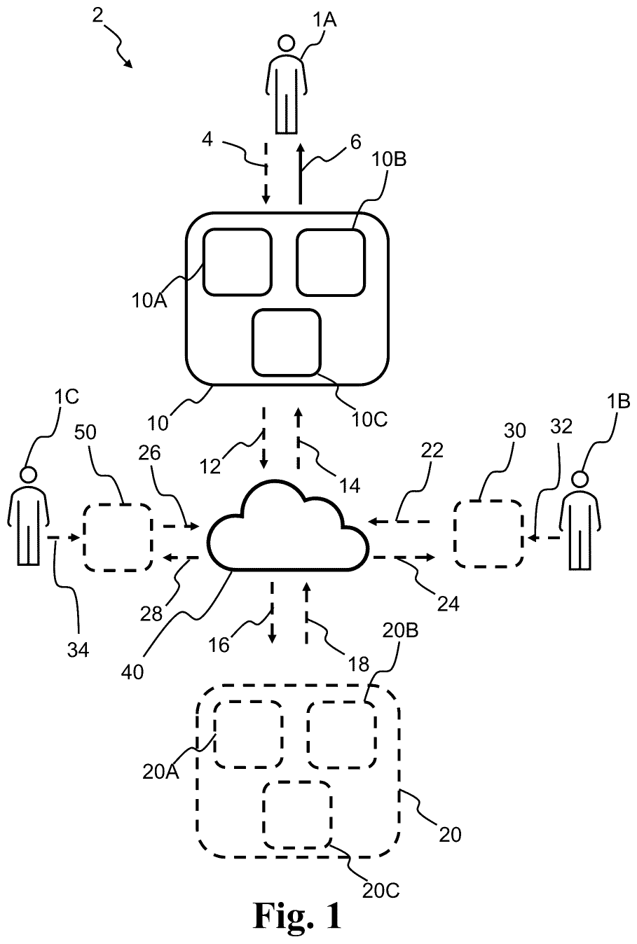

FIG. 1 schematically illustrates an exemplary supervisor feedback system, such as system 2, according to the present disclosure. The system 2 comprises an electronic device 10 and optionally a server device 20. Optionally, the system 2 comprises a first agent device 30 and/or a second agent device 50. The electronic device 10 comprises a memory 10A, one or more interfaces 10B, and one or more processors 10C. The server device 20 comprises a memory 20A, one or more interfaces 20B, and one or more processors 20C. In this example, the electronic device 10 is configured to act as a supervisor device as disclosed herein. A supervisor 1A may use the electronic device 10, e.g. being a mobile phone or a computer, for supervising and/or monitoring a plurality of agents, such as the first agent 1B and the second agent 1C. The first agent device 30 may be operated by the first agent 1B and the second agent device 50 may be operated by the second agent 1C.

The system 2 is configured to obtain, such as using a processor 10C of the supervisor device 10 and/or via an interface 10B of the supervisor device 10, first performance data comprising one or more first performance parameters associated with a performance of a first agent 1B during one or more first calls.

In one or more embodiments or examples, the first performance data may be obtained 14, e.g. via a network 40 such as a global network, e.g. the internet or a telecommunications network, by the supervisor device 10 from the first agent device 30 and/or from the server device 20. In one or more embodiments or examples, the first performance data may be obtained 16, e.g. via a network 40 such as a global network, e.g. the internet or a telecommunications network, by the server device 20 from the first agent device 30. In one or more embodiments or examples, the first performance data may be determined at the supervisor device 10, e.g., using the processor 10C and based on data obtained from the server device 20 and/or from the first agent device 30. In one or more embodiments or examples, the first performance data may be determined at the server device 20, e.g., using the processor 20C based on data obtained from the first agent device 30. In one or more embodiments or examples, the first performance data may be determined at the first agent device 30, e.g., using a processor of the first agent device 30 and then transmitted 22 to the server device 20 and/or the supervisor device 10, e.g. via a network 40 such as a global network, e.g. the internet or a telecommunications network.

The system 2 is configured to obtain, such as using the processor 10C of the supervisor device 10 and/or via the interface 10B of the supervisor device 10, second performance data comprising one or more second performance parameters associated with a performance of the second agent 1C during one or more second calls.

In one or more embodiments or examples, the second performance data may be obtained 14, e.g. via a network 40 such as a global network, e.g. the internet or a telecommunications network, by the supervisor device 10 from the second agent device 50 and/or from the server device 20. In one or more embodiments or examples, the second performance data may be obtained 16, e.g. via a network 40 such as a global network, e.g. the internet or a telecommunications network, by the server device 20 from the second agent device 50. In one or more embodiments or examples, the second performance data may be determined at the supervisor device 10, e.g., using the processor 10C and based on data obtained from the server device 20 and/or from the second agent device 50. In one or more embodiments or examples, the second performance data may be determined at the server device 20, e.g., using the processor 20C and based on data obtained from the second agent device 50. In one or more embodiments or examples, the second performance data may be determined at the second agent device 50, e.g., using a processor of the second agent device 50, and then transmitted 26 to the server device 20 and/or the supervisor device 10, e.g. via a network 40 such as a global network, e.g. the internet or a telecommunications network.

The system 2 is configured to determine, such as using the processor 10C of the supervisor device 10 and based on the first performance data and/or the second performance data, a notification scheme for notifying the supervisor 1A, such as for notifying the supervisor device 10, of the performance of the first agent 1B and/or the second agent 1C.

In one or more embodiments or examples, the notification scheme may be determined by the supervisor device 10, the first agent device 30, the second agent device 50, and/or the server device 20. In one or more embodiments or examples, the notification scheme may be determined by the first agent device 30, the second agent device 50, and/or the server device 20, and then obtained 14, e.g. via a network 40 such as a global network, e.g. the internet or a telecommunications network, by the supervisor device 10 from the first agent device 30, the second agent device 50, and/or from the server device 20.

The system 2 is configured to output, based on the notification scheme, one or more notifications. In one or more embodiments or examples, the system is configured to output, based on the notification scheme or according to the notification scheme, one or more notifications to the supervisor device 10 from the server device 20, the first agent device 30, and/or the second agent device 50. In one or more embodiments or examples, the system 2 is configured to output 6, based on the notification scheme and using the processor 10C and/or via the interface 10B of the supervisor device 10, one or more notifications. In one or more embodiments or examples, the system 2 is configured to determine, based on the notification scheme and the first performance data and/or second performance data, the one or more notifications. In one or more embodiments or examples, the one or more notifications may be determined by the supervisor device 10, the server device 20, the first agent device 30, and/or the second agent device 50. For example, the supervisor device 10 may fetch 14, e.g. via a network 40 such as a global network, e.g. the internet or a telecommunications network, the one or more notifications from the server device 20, the first agent device 30, and/or the second agent device 50. Alternatively or additionally, the server device 20, the first agent device 30, and/or the second agent device 50 may push 18, 22, 26 the one or more notifications to the supervisor device 10.

For example, the one or more notifications may notify 6 the supervisor 1A of the performance of the first agent 1B and/or the second agent 1C on the supervisor device 10.

In other words, words, the one or more notifications may provide feedback to the supervisor 1A on the performance of the first agent 1B and/or the second agent 1C on the supervisor device 10.

In one or more embodiments or examples, the system 2 is configured to determine, based on the first performance data, a first agent performance representation.

In one or more embodiments or examples, the system 2 is configured to output, such as via the interface 10B and/or using the processor 10C of the supervisor device 10, a user interface indicative of the first agent performance representation.

In one or more embodiments or examples, the system 2 is configured to determine a user interface indicative of the first agent performance representation. In one or more embodiments or examples, the system 2 is configured to display a first user interface indicative of the first agent performance representation, such as via the interface 10B. In one or more embodiments or examples, the system 2 is configured to display 6, via the interface 10B of the supervisor device 10, e.g., via a display of the supervisor device 10, a first user interface indicative of the first agent performance representation.

In one or more embodiments or examples, the system 2 is configured to obtain 14 an agent performance representation and/or a user interface by the supervisor device 10 from the first agent device 30, the second agent device 50, and/or from the server device 20. In one or more embodiments or examples, the system 2 is configured to determine an agent performance representation and/or a user interface at the first agent device 30 and/or the second agent device 50 and obtained 16 by the server device 20 from the first agent device 30 and/or the second agent device 50. In one or more embodiments or examples, the system 2 is configured to determine an agent performance representation and/or a user interface at the supervisor device 10, e.g., based on performance data obtained from the server device 20, the first agent device 30, and/or the second agent device 50. In one or more embodiments or examples, the system 2 is configured to determine an agent performance representation and/or a user interface at the server device 20, e.g., based on performance data obtained from the first agent device 30 and/or the second agent device 50. In one or more embodiments or examples, the system 2 is configured to determine an agent performance representation and/or a user interface at the first agent device 30 and/or the second agent device 50, and then transmitted to the server device 20 and/or the supervisor device 10.

In one or more embodiments or examples, the system 2 is configured to obtain a user interface object by the supervisor device 10 from the first agent device 30, the second agent device 50, and/or from the server device 20. In one or more embodiments or examples, the system 2 is configured to determine a user interface object by the first agent device 30 and/or the second agent device 50 and obtained 16 by the server device 20 from the first agent device 30 and/or the second agent device 50. In one or more embodiments or examples, the system 2 is configured to determine a user interface object at the supervisor device 10, e.g., based on performance data obtained from the server device 20, the first agent device 30, and/or the second agent device 50. In one or more embodiments or examples, the system 2 is configured to determine a user interface object at the server device 20, e.g., based on performance data obtained from the first agent device 30 and/or the second agent device 50. In one or more embodiments or examples, the system 2 is configured to determine a user interface object at the first agent device 30 and/or the second agent device 50, and then transmitted 26, 22 to the server device 20 and/or the supervisor device 10.

In one or more embodiments or examples, the system 2 is configured to obtain 4, from the supervisor 1A, such as via the interface 10B of the supervisor device 10, a first primary user input associated with the first primary user interface object. In other words, the system 2 comprises to obtain 4, from the supervisor 1A, e.g., via the interface 10B of the supervisor device 10 and via the one or more input fields, a first primary user input.

In one or more embodiments or examples, in response to the first primary user input, the system 2 is configured to output a first primary agent feedback message, e.g., output 12 from the supervisor device 10 via the interface 10B.

An agent feedback message as disclosed herein may be determined at the supervisor device 10 and be outputted 12 to the server device 20 and/or an agent device, 30, 50. An agent feedback message as disclosed herein may be determined at the server device 20 and be outputted 18 to an agent device 30, 50. In one or more embodiments or examples, the first agent device 30 is configured to output the first agent feedback message to the first agent 1B and the second agent device 50 is configured to output the second agent feedback message to the second agent 1C.

In one or more embodiments or examples, the system 2 is configured to obtain 4, from the supervisor 1A, a first secondary user input associated with the first secondary user interface object. In other words, the system 2 is configured to obtain, from the supervisor 1A, e.g., via an interface 10B of the supervisor device 10, a first secondary user input.

In one or more embodiments or examples, in response to the first secondary user input, the system 2 is configured to output the first secondary agent feedback message.

the system 2 is configured to output, such as transmitting, the first secondary agent feedback message to the first agent device 30, e.g., from the supervisor device 10 and/or the server device 20.

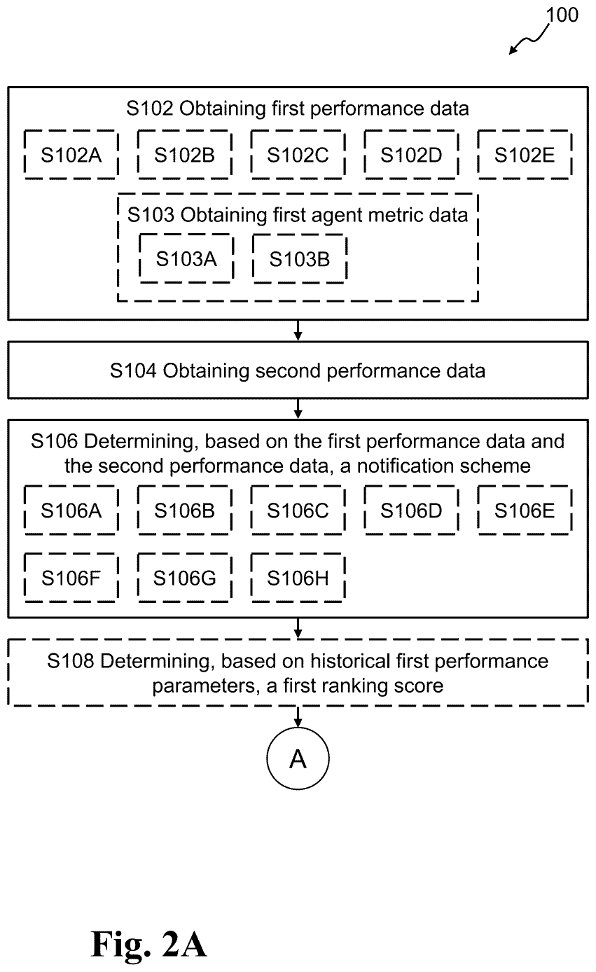

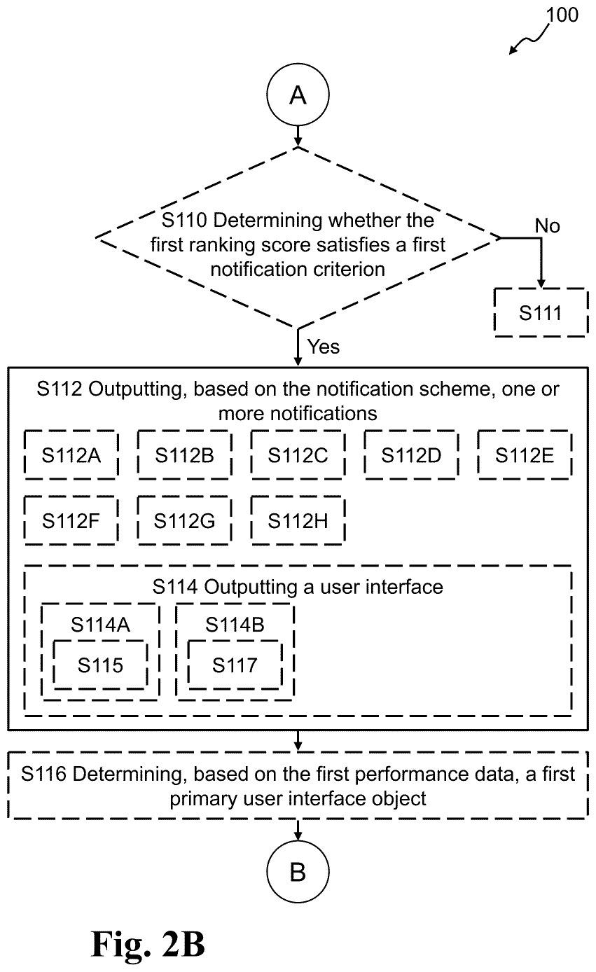

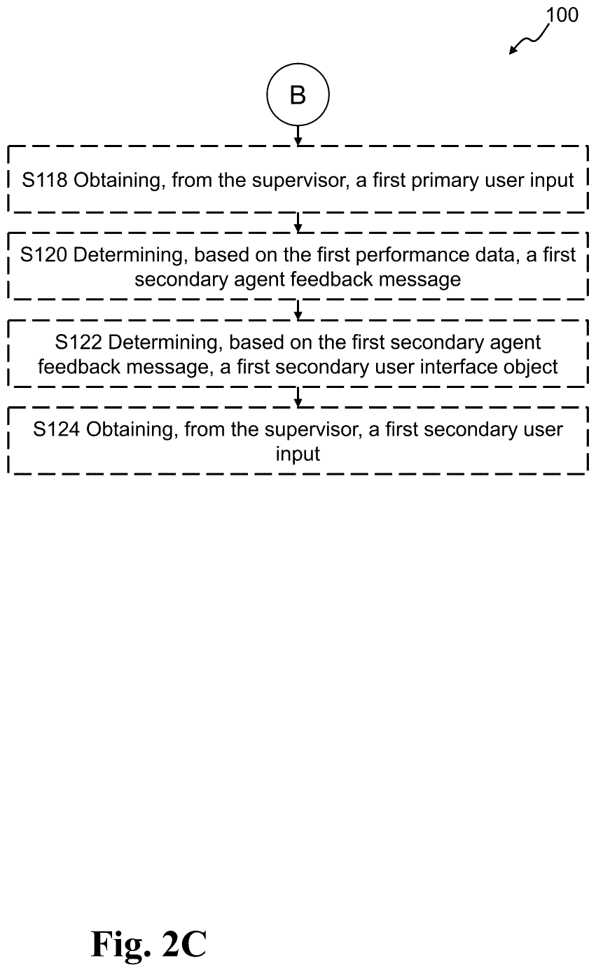

The electronic device 10 may be configured to perform any of the methods disclosed in FIGS. 2A, 2B, 2C.

The processor 10C is optionally configured to perform any of the operations disclosed in FIGS. 2A-2C (such as any one or more of S102A, S102B, S102C, S102D, S102E, S103A, S103B, S106A, S106B, S106C, S106D, S106E, S106F, S106G, S106H, S108, S110, S111, S112A, S112B, S112C, S112D, S112E, S112F, S112G, S114, S114A, S114B, S115, S117, S116, S118, S120, S122, S124). The operations of the electronic device may be embodied in the form of executable logic routines (for example, lines of code, software programs, etc.) that are stored on a non-transitory computer readable medium (for example, memory 10A) and are executed by the processor 10C).

The processor 20C is optionally configured to perform any of the operations disclosed in FIGS. 2A-2C (such as any one or more of S102A, S102B, S102C, S102D, S102E, S103A, S103B, S106A, S106B, S106C, S106D, S106E, S106F, S106G, S106H, S108, S110, S111, S112A, S112B, S112C, S112D, S112E, S112F, S112G, S114, S114A, S114B, S115, S117, S116, S118, S120, S122, S124). The operations of the server device may be embodied in the form of executable logic routines (for example, lines of code, software programs, etc.) that are stored on a non-transitory computer readable medium (for example, memory 20A) and are executed by the processor 20C).

Furthermore, the operations of the electronic device 10 may be considered a method that the electronic device 10 is configured to carry out. Also, while the described functions and operations may be implemented in software, such functionality may as well be carried out via dedicated hardware or firmware, or some combination of hardware, firmware and/or software.

Furthermore, the operations of the server device 20 may be considered a method that the server device 20 is configured to carry out. Also, while the described functions and operations may be implemented in software, such functionality may as well be carried out via dedicated hardware or firmware, or some combination of hardware, firmware and/or software.

FIGS. 2A, 2B, 2C show a flow diagram of an exemplary method.

A method 100 of operating a supervisor feedback system comprising a supervisor device, a first agent device, and a second agent device is disclosed. The method 100 comprises obtaining S102 first performance data comprising one or more first performance parameters associated with a performance of a first agent during one or more first calls. The method 100 comprises obtaining S104 second performance data comprising one or more second performance parameters associated with a performance of a second agent during one or more second calls. The method 100 comprises determining S106, based on the first performance data and the second performance data, a notification scheme for notifying a supervisor of the performance of the first agent and the second agent. The method 100 comprises outputting S112, based on the notification scheme, one or more notifications.

In one or more example methods, determining S106 a notification scheme comprises determining S106A a first notification scheme associated with the first agent. In one or more example methods, outputting S112 the one or more notifications comprises outputting S112A one or more first notifications according to the first notification scheme.

In one or more example methods, the method comprises determining S108, based on historical first performance parameters, a first ranking score of the one or more first performance parameters. In one or more example methods, the method comprises determining S110 whether the first ranking score satisfies a first notification criterion. In one or more example methods, in accordance with the first ranking score satisfying the first notification criterion, outputting S112 one or more notifications comprises outputting S112B one or more first notifications indicative of the first ranking score according to the first notification scheme. In one or more example methods, in accordance with the first ranking score not satisfying the first notification criterion, the method 100 comprises refraining S111 from outputting one or more first notifications.

In one or more example methods, obtaining S102 first performance data comprises obtaining S103 first agent metric data indicative of a metric of the first agent during the one or more first calls. In one or more example methods, obtaining S102 first performance data comprises determining S102A a first primary performance parameter based on the first agent metric data. In one or more example methods, determining S106 a notification scheme comprises determining S106B a first primary notification scheme based on the first primary performance parameter. In one or more example methods, outputting S112 one or more notifications comprises outputting S112C a first primary notification based on the first primary notification scheme.

In one or more example methods, obtaining S103 the first agent metric data comprises obtaining S103A first tone metric data indicative of a tone of the first agent during the one or more first calls. In one or more example methods, obtaining S102 the first performance data comprises determining S102B a first secondary performance parameter based on the first tone metric data. In one or more example methods, determining S106 a notification scheme comprises determining S106C a first secondary notification scheme based on the first secondary performance parameter. In one or more example methods, outputting S112 one or more notifications comprises outputting S112D a first secondary notification based on the first secondary notification scheme.

In one or more example methods, obtaining S103 the first agent metric data comprises obtaining S103B first sentiment metric data indicative of a sentiment of the first agent during the one or more first calls. In one or more example methods, obtaining S102 the first performance data comprises determining S102C a first tertiary performance parameter based on the first sentiment metric data. In one or more example methods, determining S106 a notification scheme comprises determining S106D a first tertiary notification scheme based on the first tertiary performance parameter. In one or more example methods, outputting S112 one or more notifications comprises outputting S112E a first tertiary notification based on the first tertiary notification scheme.

In one or more example methods, obtaining S102 the first performance data comprises obtaining S102D first interlocutor metric data indicative of a metric of a first interlocutor during the one or more first calls. In one or more example methods, obtaining S102 the first performance data comprises determining S102E a first quaternary performance parameter based on the first interlocutor metric data. In one or more example methods, determining S106 a notification scheme comprises determining S106E a first quaternary notification scheme based on the first quaternary performance parameter. In one or more example methods, outputting S112 one or more notifications comprises outputting S112F a first quaternary notification based on the first quaternary notification scheme.

In one or more example methods, determining S106 the notification scheme comprises determining S106F, based on the first tone metric data and/or the first sentiment metric data, a first quinary notification scheme. In one or more example methods, outputting S112 one or more notifications comprises outputting S112G, based on the first quinary notification scheme, a first quinary notification indicative of a state of the first agent during the one or more first calls.

In one or more example methods, determining S106 a notification scheme comprises determining S106G, based on the first performance data, a first agent performance representation. In one or more example methods, outputting S112 one or more notifications comprises outputting S114 a user interface indicative of the first agent performance representation.

In one or more example methods, the method comprises determining S116, based on the first performance data, a first primary user interface object comprising one or more input fields. In one or more example methods, outputting S114 the user interface comprises outputting S114A a first primary user interface comprising the first primary user interface object.

In one or more example methods, the method comprises obtaining S118, from the supervisor, a first primary user input associated with the first primary user interface object.

In one or more example methods, in response to the first primary user input, outputting S114A the first primary user interface comprises outputting S115 a first primary agent feedback message.

In one or more example methods, the method comprises determining S120, based on the first performance data, a first secondary agent feedback message. In one or more example methods, the method comprises determining S122, based on the first secondary agent feedback message, a first secondary user interface object. In one or more example methods, outputting S114 the user interface comprises outputting S114B a first secondary user interface comprising the first secondary user interface object.

In one or more example methods, the method comprises obtaining S124, from the supervisor, a first secondary user input associated with the first secondary user interface object. In one or more example methods, in response to the first secondary user input, outputting S114B the first secondary user interface comprises outputting S117 the first secondary agent feedback message.

In one or more example methods, determining S106 the notification scheme comprises determining S106H one or more first timing parameters based on one or more of: an activity of the first agent, a time-zone of the first agent and/or the supervisor, and calendar data of the first agent and/or the supervisor. In one or more example methods, outputting S112 the one or more notifications comprises outputting S112H the one or more notifications based on the one or more first timing parameters.

Examples of electronic devices, systems, and methods according to the disclosure are set out in the following items:

Item 1. A method (100) of operating a supervisor feedback system comprising a supervisor device, a first agent device, and a second agent device, the method comprising:
obtaining (S102) first performance data comprising one or more first performance parameters associated with a performance of a first agent during one or more first calls;
obtaining (S104) second performance data comprising one or more second performance parameters associated with a performance of a second agent during one or more second calls;
determining (S106), based on the first performance data and the second performance data, a notification scheme for notifying a supervisor of the performance of the first agent and the second agent; and
outputting (S112), based on the notification scheme, one or more notifications.

Item 2. Method according to item 1, wherein determining (S106) a notification scheme comprises determining (S106A) a first notification scheme associated with the first agent, and wherein outputting (S112) the one or more notifications comprises outputting (S112A) one or more first notifications according to the first notification scheme.

Item 3. Method according to item 2, the method comprising:
determining (S108), based on historical first performance parameters, a first ranking score of the one or more first performance parameters;
determining (S110) whether the first ranking score satisfies a first notification criterion; and
   in accordance with the first ranking score satisfying the first notification criterion:
outputting (S112) one or more notifications comprises outputting (S112B) one or more first notifications indicative of the first ranking score according to the first notification scheme.

Item 4. Method according to any of the previous items, wherein obtaining (S102) first performance data comprises obtaining (S103) first agent metric data indicative of a metric of the first agent during the one or more first calls and determining (S102A) a first primary performance parameter based on the first agent metric data, wherein determining (S106) a notification scheme comprises determining (S106B) a first primary notification scheme based on the first primary performance parameter, and wherein outputting (S112) one or more notifications comprises outputting (S112C) a first primary notification based on the first primary notification scheme.

Item 5. Method according to item 4, wherein obtaining (S103) the first agent metric data comprises obtaining (S103A) first tone metric data indicative of a tone of the first agent during the one or more first calls, and wherein obtaining (S102) the first performance data comprises determining (S102B) a first secondary performance parameter based on the first tone metric data, wherein determining (S106) a notification scheme comprises determining (S106C) a first secondary notification scheme based on the first secondary performance parameter, and wherein outputting (S112) one or more notifications comprises outputting (S112D) a first secondary notification based on the first secondary notification scheme.

Item 6. Method according to any of items 4-5, wherein obtaining (S103) the first agent metric data comprises obtaining (S103B) first sentiment metric data indicative of a sentiment of the first agent during the one or more first calls, wherein obtaining (S102) the first performance data comprises determining (S102C) a first tertiary performance parameter based on the first sentiment metric data, wherein determining (S106) a notification scheme comprises determining (S106D) a first tertiary notification scheme based on the first tertiary performance parameter, and wherein outputting (S112) one or more notifications comprises outputting (S112E) a first tertiary notification based on the first tertiary notification scheme.

Item 7. Method according to any of the previous items, wherein obtaining (S102) the first performance data comprises obtaining (S102D) first interlocutor metric data indicative of a metric of a first interlocutor during the one or more first calls and determining (S102E) a first quaternary performance parameter based on the first interlocutor metric data, wherein determining (S106) a notification scheme comprises determining (S106E) a first quaternary notification scheme based on the first quaternary performance parameter, and wherein outputting (S112) one or more notifications comprises outputting (S112F) a first quaternary notification based on the first quaternary notification scheme.

Item 8. Method according to any of items 4-7, wherein determining (S106) the notification scheme comprises determining (S106F), based on the first tone metric data and/or the first sentiment metric data, a first quinary notification scheme, and wherein outputting (S112) one or more notifications comprises outputting (S112G), based on the first quinary notification scheme, a first quinary notification indicative of a state of the first agent during the one or more first calls.

Item 9. Method according to any of the previous items, wherein determining (S106) a notification scheme comprises determining (S106G), based on the first performance data, a first agent performance representation; and wherein outputting (S112) one or more notifications comprises outputting (S114) a user interface indicative of the first agent performance representation.

Item 10. Method according to item 9, the method comprising:
determining (S116), based on the first performance data, a first primary user interface object comprising one or more input fields; and
wherein outputting (S114) the user interface comprises outputting (S114A) a first primary user interface comprising the first primary user interface object.

Item 11. Method according to item 10, the method comprising:
obtaining (S118), from the supervisor, a first primary user input associated with the first primary user interface object; and
in response to the first primary user input, outputting (S114A) the first primary user interface comprises outputting (S115) a first primary agent feedback message.

Item 12. Method according to any of items 9-11, the method comprising:
determining (S120), based on the first performance data, a first secondary agent feedback message;
determining (S122), based on the first secondary agent feedback message, a first secondary user interface object; and
wherein outputting (S114) the user interface comprises outputting (S114B) a first secondary user interface comprising the first secondary user interface object.

Item 13. Method according to item 12, the method comprising:
obtaining (S124), from the supervisor, a first secondary user input associated with the first secondary user interface object; and
in response to the first secondary user input, outputting (S114B) the first secondary user interface comprises outputting (S117) the first secondary agent feedback message.

Item 14. Method according to any of the previous items, wherein determining (S106) the notification scheme comprises determining (S106H) one or more first timing parameters based on one or more of: an activity of the first agent, a time-zone of the first agent and/or the supervisor, and calendar data of the first agent and/or the supervisor, and wherein outputting (S112) the one or more notifications comprises outputting (S112H) the one or more notifications based on the one or more first timing parameters.

Item 15. Electronic device (10) comprising a memory (10A), an interface (10B), and one or more processors (10C), wherein the one or more processors (10C) are configured to:
obtain first performance data comprising one or more first performance parameters associated with a performance of a first agent during one or more first calls;
obtain second performance data comprising one or more second performance parameters associated with a performance of a second agent during one or more second calls;
determine, based on the first performance data and the second performance data, a notification scheme for notifying a supervisor of the performance of the first agent and the second agent; and
output, based on the notification scheme, one or more notifications.

Item 16. Electronic device according to item 15, wherein to determine a notification scheme comprises to determine a first notification scheme associated with the first agent, and wherein to output the one or more notifications comprises to output one or more first notifications according to the first notification scheme.

Item 17. Electronic device according to item 16, the one or more processors are configured to:

determine, based on historical first performance parameters, a first ranking score of the one or more first performance parameters;
determine whether the first ranking score satisfies a first notification criterion; and
   in accordance with the first ranking score satisfying the first notification criterion:

to output one or more notifications comprises to output one or more first notifications indicative of the first ranking score according to the first notification scheme.

Item 18. Electronic device according to any of the previous items, wherein to obtain first performance data comprises to obtain first agent metric data indicative of a metric of the first agent during the one or more first calls and to determine a first primary performance parameter based on the first agent metric data, wherein to determine a notification scheme comprises to determine a first primary notification scheme based on the first primary performance parameter, and wherein to output one or more notifications comprises to output a first primary notification based on the first primary notification scheme.

Item 19. Electronic device according to item 18, wherein to obtain the first agent metric data comprises to obtain first tone metric data indicative of a tone of the first agent during the one or more first calls, and wherein to obtain the first performance data comprises to determine a first secondary performance parameter based on the first tone metric data, wherein to determine a notification scheme comprises to determine a first secondary notification scheme based on the first secondary performance parameter, and wherein to output one or more notifications comprises to output a first secondary notification based on the first secondary notification scheme.

Item 20. Electronic device according to any of items 18-19, wherein to obtain the first agent metric data comprises to obtain first sentiment metric data indicative of a sentiment of the first agent during the one or more first calls, wherein to obtain the first performance data comprises to determine a first tertiary performance parameter based on the first sentiment metric data, wherein to determine a notification scheme comprises to determine a first tertiary notification scheme based on the first tertiary performance parameter, and wherein to output one or more notifications comprises to output a first tertiary notification based on the first tertiary notification scheme.

Item 21. Electronic device according to any of items 15-20, wherein to obtain the first performance data comprises to obtain first interlocutor metric data indicative of a metric of a first interlocutor during the one or more first calls and to determine a first quaternary performance parameter based on the first interlocutor metric data, wherein to determine a notification scheme comprises to determine a first quaternary notification scheme based on the first quaternary performance parameter, and wherein to output one or more notifications comprises to output a first quaternary notification based on the first quaternary notification scheme.

Item 22. Electronic device according to any of items 18-21, wherein to determine the notification scheme comprises to determine, based on the first tone metric data and/or the first sentiment metric data, a first quinary notification scheme, and wherein to output one or more notifications comprises to output, based on the first quinary notification scheme, a first quinary notification indicative of a state of the first agent during the one or more first calls.

Item 23. Electronic device according to any of items 15-22, wherein to determine a notification scheme comprises to determine, based on the first performance data, a first agent performance representation; and
wherein to output one or more notifications comprises to output a user interface indicative of the first agent performance representation.

Item 24. Electronic device according to item 23, wherein the one or more processors are configured to:
determine, based on the first performance data, a first primary user interface object comprising one or more input fields; and
wherein to output the user interface comprises to output a first primary user interface comprising the first primary user interface object.

Item 25. Electronic device according to item 24, wherein the one or more processors are configured to:
obtain, from the supervisor, a first primary user input associated with the first primary user interface object; and
in response to the first primary user input, to output the first primary user interface comprises to output a first primary agent feedback message.

Item 26. Electronic device according to any of items 23-25, wherein the one or more processors are configured to:
determine, based on the first performance data, a first secondary agent feedback message;
determine, based on the first secondary agent feedback message, a first secondary user interface object; and
wherein to output the user interface comprises to output a first secondary user interface comprising the first secondary user interface object.

Item 27. Electronic device according to item 26, wherein the one or more processors are configured to:
obtain, from the supervisor, a first secondary user input associated with the first secondary user interface object; and
in response to the first secondary user input, to output the first secondary user interface comprises to output the first secondary agent feedback message.

Item 28. Electronic device according to any of items 15-20, wherein to determine the notification scheme comprises to determine one or more first timing parameters based on one or more of: an activity of the first agent, a time-zone of the first agent and/or the supervisor, and calendar data of the first agent and/or the supervisor, and wherein to output the one or more notifications comprises to output the one or more notifications based on the one or more first timing parameters.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering.

Memory may be one or more of a buffer, a flash memory, a hard drive, a removable media, a volatile memory, a non-volatile memory, a random access memory (RAM), or other suitable device. In a typical arrangement, memory may include a non-volatile memory for long term data storage and a volatile memory that functions as system memory for the processor. Memory may exchange data with processor over a data bus. Memory may be considered a non-transitory computer readable medium.

Memory may be configured to store information (such as information indicative of first performance data, first performance parameters, second performance data, second performance parameters, notification schemes, notifications, historical performance parameters, performance representations, user interfaces, user interface objects, feedback messages, and/or timing parameter) in a part of the memory.

Furthermore, the labelling of a first element does not imply the presence of a second element and vice versa.

It may be appreciated that FIGS. 1-2C comprise some modules or operations which are illustrated with a solid line and some modules or operations which are illustrated with a dashed line. The modules or operations which are comprised in a solid line are modules or operations which are comprised in the broadest example embodiment. The modules or operations which are comprised in a dashed line are example embodiments which may be comprised in, or a part of, or are further modules or operations which may be taken in addition to the modules or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, and systems described herein are described in the general context of method steps processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform specified tasks or implement specific abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed invention, and it will be made obvious to those skilled in the art that various changes and modifications may be made without departing from the spirit and scope of the claimed invention. The specification and drawings are, accordingly, to be regarded in an illustrative rather than restrictive sense. The claimed invention is intended to cover all alternatives, modifications, and equivalents.

### LIST OF REFERENCES

1A supervisor
1B first agent
1C second agent
2 system
4 user input
6 notification, supervisor output
10 electronic device
10A memory
10B one or more interfaces
10C one or more processors
12 transmit
14 obtain
16 obtain
18 transmit
20 server device
20A memory
20B one or more interfaces
20C one or more processors
22 transmit
24 obtain
26 transmit
28 obtain
30 first agent device
32 first agent input
34 second agent input
40 network
50 second agent device
100 method of operating a supervisor feedback system
S102 obtaining first performance data
S102A determining a first primary performance parameter
S102B determining a first secondary performance parameter
S102C determining a first tertiary performance parameter
S102D obtaining first interlocutor metric data
S102E determining a first quaternary performance parameter
S103 obtaining first agent metric data
S103A obtaining first tone metric data
S103B obtaining first sentiment metric data
S104 obtaining second performance delta
S106 determining a notification scheme
S106A determining a first notification scheme
S106B determining a first primary notification scheme
S106C determining a first secondary notification scheme
S106D determining a first tertiary notification scheme
S106E determining a first quaternary notification scheme
S106F determining a first quinary notification scheme
S106G determining a first agent performance representation
S106H determining one or more first timing parameters
S108 determining a first ranking score
S110 determining whether the first ranking score satisfies a first notification criterion
S111 refrain from outputting one or more notifications
S112 outputting one or more notifications
S112A outputting one or more first notifications according to the first notification scheme
S112B outputting one or more first notifications indicative of first ranking score
S112C outputting a first primary notification
S112D outputting a first secondary notification
S112E outputting a first tertiary notification
S112F outputting a first quaternary notification
S112G outputting a first quinary notification
S112H outputting one or more notifications based on the one or more first timing parameters
S114 outputting a user interface
S114A outputting a first primary user interface
S114B outputting a first secondary user interface
S115 outputting a first primary agent feedback message
S116 determining a first primary user interface object
S117 outputting the first secondary agent feedback message
S118 obtaining a first primary user input
S120 determining a first secondary agent feedback message
S122 determining a first secondary user interface object
S124 obtaining a first secondary user input

1. A method of operating a supervisor feedback system comprising a supervisor device, a first agent device, and a second agent device, the method comprising:
obtaining first performance data comprising one or more first performance parameters associated with a performance of a first agent during one or more first calls;
obtaining second performance data comprising one or more second performance parameters associated with a performance of a second agent during one or more second calls;
determining, based on the first performance data and the second performance data, a notification scheme for notifying a supervisor of the performance of the first agent and the second agent, wherein determining a notification scheme comprises determining a first notification scheme associated with the first agent; and
outputting, based on the notification scheme, one or more notifications, wherein outputting the one or more first notifications comprises outputting one or more first notifications according to the first notification scheme.

2. (canceled)

3. Method according to claim 12, the method comprising:
determining, based on historical first performance parameters, a first ranking score of the one or more first performance parameters;
determining whether the first ranking score satisfies a first notification criterion; and
in accordance with the first ranking score satisfying the first notification criterion:
outputting one or more notifications comprises outputting one or more first notifications indicative of the first ranking score according to the first notification scheme.

4. Method according to claim 1, wherein obtaining first performance data comprises obtaining first agent metric data indicative of a metric of the first agent during the one or more first calls and determining a first primary performance parameter based on the first agent metric data, wherein determining a notification scheme comprises determining a first primary notification scheme based on the first primary performance parameter, and wherein outputting one or more notifications comprises outputting a first primary notification based on the first primary notification scheme.

5. Method according to claim 4, wherein obtaining 33 the first agent metric data comprises obtaining first tone metric data indicative of a tone of the first agent during the one or more first calls, and wherein obtaining the first performance data comprises determining a first secondary performance parameter based on the first tone metric data, wherein determining a notification scheme comprises determining a first secondary notification scheme based on the first secondary performance parameter, and wherein outputting one or more notifications comprises outputting a first secondary notification based on the first secondary notification scheme.

6. Method according to claim 4, wherein obtaining the first agent metric data comprises obtaining first sentiment metric data indicative of a sentiment of the first agent during the one or more first calls, wherein obtaining the first performance data comprises determining a first tertiary performance parameter based on the first sentiment metric data, wherein determining a notification scheme comprises determining a first tertiary notification scheme based on the first tertiary performance parameter, and wherein outputting one or more notifications comprises outputting a first tertiary notification based on the first tertiary notification scheme.

7. Method according to claim 1, wherein obtaining the first performance data comprises obtaining first interlocutor metric data indicative of a metric of a first interlocutor during the one or more first calls and determining a first quaternary performance parameter based on the first interlocutor metric data, wherein determining a notification scheme comprises determining-first quaternary notification scheme based on the first quaternary performance parameter, and wherein outputting one or more notifications comprises outputting a first quaternary notification based on the first quaternary notification scheme.

8. Method according to claim 4, wherein determining the notification scheme comprises determining, based on the first tone metric data and/or the first sentiment metric data, a first quinary notification scheme, and wherein outputting one or more notifications comprises outputting, based on the first quinary notification scheme, a first quinary notification indicative of a state of the first agent during the one or more first calls.

9. Method according to claim 1, wherein determining a notification scheme comprises determining, based on the first performance data, a first agent performance representation; and
wherein outputting one or more notifications comprises outputting a user interface indicative of the first agent performance representation.

10. Method according to claim 9, the method comprising:
determining, based on the first performance data, a first primary user interface object comprising one or more input fields; and
wherein outputting the user interface comprises outputting a first primary user interface comprising the first primary user interface object.

11. Method according to claim 10, the method comprising:
obtaining, from the supervisor, a first primary user input associated with the first primary user interface object; and
in response to the first primary user input, outputting the first primary user interface comprises outputting a first primary agent feedback message.

12. Method according to claim 9, the method comprising:
determining, based on the first performance data, a first secondary agent feedback message;
determining, based on the first secondary agent feedback message, a first secondary user interface object; and
wherein outputting the user interface comprises outputting a first secondary user interface comprising the first secondary user interface object.

13. Method according to claim 12, the method comprising:
obtaining, from the supervisor, a first secondary user input associated with the first secondary user interface object; and
in response to the first secondary user input, outputting the first secondary user interface comprises outputting the first secondary agent feedback message.

14. Method according to claim 1, wherein determining the notification scheme comprises determining one or more first timing parameters based on one or more of: an activity of the first agent, a time-zone of the first agent and/or the supervisor, and calendar data of the first agent and/or the supervisor, and wherein outputting the one or more notifications comprises outputting the one or more notifications based on the one or more first timing parameters.

15. Electronic device comprising a memory, an interface, and one or more processors, wherein the one or more processors are configured to:
obtain first performance data comprising one or more first performance parameters associated with a performance of a first agent during one or more first calls;
obtain second performance data comprising one or more second performance parameters associated with a performance of a second agent during one or more second calls;
determine, based on the first performance data and the second performance data, a notification scheme for notifying a supervisor of the performance of the first agent and the second agent, wherein to determine a notification scheme comprises to determine a first notification scheme associated with the first agent; and
output, based on the notification scheme, one or more notifications, wherein to output the one or more notification comprises to output one or more first notifications according to the first notification scheme.

16. Electronic device according to claim 15, the one or more processors are configured to:
determine, based on historical first performance parameters, a first ranking score of the one or more first performance parameters;
determine whether the first ranking score satisfies a first notification criterion; and in accordance with the first ranking score satisfying the first notification criterion:
to output one or more notifications comprises to output one or more first notifications indicative of the first ranking score according to the first notification scheme.

17. Electronic device according to claim 15, wherein to obtain first performance data comprises to obtain first agent metric data indicative of a metric of the first agent during the one or more first calls and to determine a first primary performance parameter based on the first agent metric data, wherein to determine a notification scheme comprises to determine a first primary notification scheme based on the first primary performance parameter, and wherein to output one or more notifications comprises to output a first primary notification based on the first primary notification scheme.

18. Electronic device according to claim 17, wherein to obtain the first agent metric data comprises to obtain first tone metric data indicative of a tone of the first agent during the one or more first calls, and wherein to obtain the first performance data comprises to determine a first secondary performance parameter based on the first tone metric data, wherein to determine a notification scheme comprises to determine a first secondary notification scheme based on the first secondary performance parameter, and wherein to output one or more notifications comprises to output a first secondary notification based on the first secondary notification scheme.

19. Electronic device according to claim 17, wherein to obtain the first agent metric data comprises to obtain first sentiment metric data indicative of a sentiment of the first agent during the one or more first calls, wherein to obtain the first performance data comprises to determine a first tertiary performance parameter based on the first sentiment metric data, wherein to determine a notification scheme comprises to determine a first tertiary notification scheme based on the first tertiary performance parameter, and wherein to output one or more notifications comprises to output a first tertiary notification based on the first tertiary notification scheme.

20. Electronic device according to claim 15, wherein to obtain the first performance data comprises to obtain first interlocutor metric data indicative of a metric of a first interlocutor during the one or more first calls and to determine a first quaternary performance parameter based on the first interlocutor metric data, wherein to determine a notification scheme comprises to determine a first quaternary notification scheme based on the first quaternary performance parameter, and wherein to output one or more notifications comprises to output a first quaternary notification based on the first quaternary notification scheme.

21. Electronic device according to claim 17, wherein to determine the notification scheme comprises to determine, based on the first tone metric data and/or the first sentiment metric data, a first quinary notification scheme, and wherein to output one or more notifications comprises to output, based on the first quinary notification scheme, a first quinary notification indicative of a state of the first agent during the one or more first calls.
